(19) United States
(12) Patent Application Publication
(10) Pub. No.: US 2016/0378950 A1
(43) Pub. Date: Dec. 29, 2016

(54) METHOD AND APPARATUS FOR TRACKING A PHARMACEUTICAL

(71) Applicant: Bruce REINER, Berlin, MD (US)

(72) Inventor: Bruce REINER, Berlin, MD (US)

(21) Appl. No.: 15/196,538

(22) Filed: Jun. 29, 2016

Related U.S. Application Data
(60) Provisional application No. 62/185,952, filed on Jun. 29, 2015.

(51) Int. Cl. G06F 19/00; G06F 17/30

(52) U.S. Cl. CPC G06F 19/3456; G06F 17/30867; G06F 19/322

(57) ABSTRACT

The present invention relates to creating an all-inclusive methodology for data collection and analysis which can serve as a vehicle for pharmaceutical meta-analysis and creation of data-driven best practice guidelines, which represents the cornerstone of evidence based medicine. The present invention includes a number of unique components which record standardized_data throughout a multi-step and multi-stakeholder process, with the end result of creating a standardized method for creating, collecting, storing, communicating, and analyzing data related to the multi-step process of pharmaceutical administration in healthcare. In the course of doing so, a number of unique profiles are created which account for patient and provider differences, which are important in identifying compliance risk factors, causation, intervention, and treatment strategies.

### CROSS-REFERENCE TO RELATED APPLICATIONS

The present invention claims priority to U.S. Provisional Patent Application No. 62/185,952, filed Jun. 29, 2015, the contents of which are herein incorporated by reference in their entirety.

### BACKGROUND OF THE INVENTION

Field of the Invention:

The present invention relates to an all-inclusive methodology for data collection and analysis which can serve as a vehicle for pharmaceutical meta-analysis and creation of data-driven best practice guidelines, which represents the cornerstone of evidence based medicine (EBM). The present invention includes a number of unique components which record standardized data throughout a multi-step and multi-stakeholder process. In the course of doing so, a number of unique profiles are created which account for patient and provider differences, which are important to identifying compliance risk factors, causation, intervention, and treatment strategies.

Description of the Related Art:

While healthcare costs continue to escalate and represent a larger percentage of the gross national product, one of the most important concerns is that of wasteful and avoidable costs. It has been estimated that between $100-$300 billion of avoidable annual costs in U.S healthcare is attributed to pharmaceutical noncompliance, which represents 3-10% of total annual healthcare expenditures. Prescription drug cost is the fastest growing component of healthcare costs in the U.S. and is expected to grow an additional 9-13% annually in the next decade.

Pharmaceutical compliance is defined as the taking of medication as prescribed, on time, and at the correct dose; while persistence is defined as the continuing use of the prescribed drug. Both compliance and persistence play critical roles in determining clinical outcomes, especially in chronic disease, with the compliance rate for long term medication estimated to be only 40-50% (meaning half of all patients demonstrating noncompliance). In the absence of effective intervention, the negative effects of pharmaceutical noncompliance will continue to worsen with the aging of the U.S. population. Currently, 49% of all adult Americans take at least 1 prescription drug daily, with a recent doubling in the percentage of patients taking ≧3 drugs daily.

Pharmaceutical noncompliance can take many forms including not filling of a prescription, taking an incorrect dose, taking medications at incorrect times, increasing or decreasing dose frequency, premature termination of treatment, taking “drug holidays” (i.e., stopping and restarting therapy independent of the prescribe regimen), and “white coat compliance” (compliance to medication around times of scheduled physician appointments with noncompliance at other times). Studies indicate nearly 20% of all prescriptions go unfilled, while 85% of follow up prescriptions do not get refilled.

The negative impact of pharmaceutical noncompliance on clinical outcomes has been well documented, and has been reported to contribute to an estimated 125,000 annual deaths in the U.S. and up to 20% of all hospital and nursing home admissions. In addition to increasing hospital admissions, pharmaceutical noncompliance has been associated with increased length of hospitalizations, disease progression, increased utilization of outpatient services, avoidable clinical testing, and increased pharmacy costs due to therapy intensification. One of the more insidious and difficult to quantify negative clinical outcome effects caused by pharmaceutical noncompliance is the alteration of drug therapy by physicians due to lack of therapeutic response.

One of the challenges in addressing pharmaceutical noncompliance is the wide array and diversity of contributing factors which include (but are not limited to) patient forgetfulness, memory loss, lack of disease awareness, medication side effects, substance/alcohol abuse, poor patient-provider communication, limited education, and poor health literacy.

Thus, creating effective interventional strategies to counteract pharmaceutical noncompliance requires a comprehensive approach to the multitude of causative factors and diversity of patients, along with the creation of effective data tracking tools. In particular, effectively formulating strategies for combatting patient noncompliance, requires providing a systematic approach and longitudinal data analysis, beginning at the time a prescription order is placed, to the time the entire dose has been completed, including continuous tracking of individual dose administration. Since patients with chronic disease require long term medical therapy, this process is essentially ongoing and may extend over the lifetime of the patient. As each individual prescription cycle is completed, the treating physician will elect to change medication, adjust medication dosage, discontinue the medication, or continue with the same medical therapy, in accordance with therapeutic response. In order to assess the therapeutic efficacy of medication therapy (i.e., clinical outcomes analysis), it is important to continuously track, monitor, and analyze this longitudinal data; which in effect becomes the ongoing pharmaceutical data tracking and analysis tool of the present invention.

While individual technologies currently exist to track individual steps in the collective process of pharmaceutical administration (e.g., smart pills, smart storage devices), no comprehensive process currently exists which records, tracks, analyzes and provides real-time feedback data for all of these individual steps, technologies, and participating stakeholders.

Further, in current practice, one of the greatest challenges in creating EBM practice guidelines is the diversity (i.e., heterogeneity) of pharmaceuticals, disease, patients, and clinical care providers. Existing evidence-based medicine (EBM) practice and guidelines tend to combine individuals within these diverse groups which can result in erroneous conclusions and treatment strategies. As an example, one attempts to create pharmaceutical compliance standards and treatment strategies for patients with renal disease. If individual subsets of these patients have comorbidities (i.e., additional disease) such as cognitive impairment, substance abuse, or limited health literacy the defined strategies may be impractical and result in unexpectedly poor compliance and treatment outcomes. A patient with memory impairment may require additional sensory aides and prompts to assist with pharmaceutical administration when compared with a patient with intact memory; and as a result needs to be evaluated in an entirely different manner. The end result is that pharmaceutical compliance analysis and creation of best practice guidelines are complex processes influenced by a large number of variables and interaction effects attributable to pharmaceuticals, patients, providers, technology, and disease.

Accordingly, a method and apparatus to track data related to the individual steps of pharmaceutical ordering, dispersal, administration, and reordering, which extends into a number of unique areas which impact security, patient and provider diversity, safety, communication, education, decision support, intervention, and outcomes analysis, is required.

### SUMMARY OF THE INVENTION

The present invention relates to creating an all-inclusive methodology for data collection and analysis which can serve as a vehicle for pharmaceutical meta-analysis and creation of data-driven best practice guidelines, which represents the cornerstone of evidence based medicine (EBM). The present invention includes a number of unique components which record standardized data throughout a multi-step and multi-stakeholder process. In the course of doing so, a number of unique profiles are created which account for patient and provider differences, which are important in identifying compliance risk factors, causation, intervention, and treatment strategies.

In one embodiment, a computer-implemented method of tracking pharmaceuticals, includes: receiving data on a plurality of participants and a plurality of pharmaceutical agents in a registration process, and storing the data in a database of a computer system; receiving input on a pharmaceutical agent for an individual participant and storing the input on the pharmaceutical agent in the database; displaying on a display of the computer system, a timeline for the individual participant, summarizing a pharmaceutical history of the individual participant for all pharmaceutical prescriptions and pharmaceutical agents stored in the database; analyzing data in the database, using a processor of the computer system, wherein on condition that the pharmaceutical agent is one of the plurality of pharmaceutical agents, and on condition that the individual participant is one of the plurality of participants, determining a clinical appropriateness of the pharmaceutical agent for the individual participant; displaying, on a display of the computer system, default data from the database on the pharmaceutical agent, to complete standardized data fields on the pharmaceutical agent for the individual participant; and verifying that the completed data fields on the pharmaceutical agent for the individual participant are consistent with industry standards and clinical guidelines.

In one embodiment, the present invention includes notifying a health care professional of any discrepancy in the completed data fields, from the industry standards and the accepted clinical practice, using electronic means; and forwarding alternative or corrective options to said healthcare professional using the electronic means, that would modify the completed data fields and obviate the discrepancy.

In one embodiment, the healthcare professional can one of accept the default data in the standardized data fields in a pharmaceutical order, and complete the registration process, or modify the default data in the standardized fields in accordance with clinical requirements of the healthcare professional.

In one embodiment, on condition that the healthcare professional does not accept the alternative or corrective options, requiring an audit of said default data and a quality assurance review of the data in the pharmaceutical order by another healthcare professional, to obtain consensus between the healthcare professional and the another healthcare professional.

In one embodiment, on condition that consensus is not reached between the healthcare professional and another healthcare professional, the healthcare professional may override any modifications in the pharmaceutical order regarding the discrepancy.

In one embodiment, on condition that consensus is achieved between the healthcare professional and another healthcare professional, recording a result of any audit, and completing the registration process with any modifications in the pharmaceutical order.

In one embodiment, on condition that any modification in the pharmaceutical order are overridden regarding the discrepancy by the healthcare professional, and the pharmaceutical order falls outside industry standards and clinical guidelines, instituting a formal review of the pharmaceutical order by another healthcare professional and requiring consensus before the pharmaceutical order is accepted and the registration process is completed.

In one embodiment, the present invention includes receiving modifications to the pharmaceutical agent in the database for an individual participant, and providing a revised pharmaceutical profile of the individual participant to the healthcare professional.

In one embodiment, on condition that the modifications to the pharmaceutical agent fall outside industry standards and clinical guidelines, instituting a formal review of the pharmaceutical order by another healthcare professional and requiring consensus before the modifications to the pharmaceutical agent are accepted.

In one embodiment, the present invention includes notifying the individual participant each time the data in the database on the individual participant, is accessed by a healthcare professional.

In one embodiment, the individual participant can modify access by individual healthcare professionals, to the data on the individual participant in the database.

In one embodiment, the present invention includes verifying the plurality of participants using at least one of demographic, occupational, education, training, licensing, credentialing, certification, and medico-legal data.

In one embodiment, the verification step includes the use of biometrics, speech analysis, and unique data identifiers, and the verification step takes place each time an individual participant or a healthcare professional, accesses the database.

In one embodiment, a system which tracks pharmaceuticals, includes: at least one memory which contains at least one program which includes the executable instructions of: receiving data on a plurality of participants and a plurality of pharmaceutical agents in a registration process, and storing the data in a database of a computer system; receiving input on a pharmaceutical agent for an individual participant and storing the input on the pharmaceutical agent in the database; displaying on a display of the computer system, a timeline for the individual participant, summarizing a pharmaceutical history of the individual participant for all pharmaceutical prescriptions and pharmaceutical agents stored in the database; analyzing data in the database, using a processor of the computer system, wherein on condition that the pharmaceutical agent is one of said plurality of pharmaceutical agents, and on condition that the individual participant is one of the plurality of participants, determining a clinical appropriateness of the pharmaceutical agent for the individual participant; displaying, on a display of the computer system, default data from the database on the pharmaceutical agent, to complete standardized data fields on the pharmaceutical agent for the individual participant; and verifying that the completed data fields on the pharmaceutical agent for the individual participant are consistent with industry standards and clinical guidelines; and at least one processor which executes the program.

In one embodiment, a non-transitory computer-readable medium which includes instructions for tracking pharmaceuticals, includes: receiving data on a plurality of participants and a plurality of pharmaceutical agents in a registration process, and storing the data in a database of a computer system; receiving input on a pharmaceutical agent for an individual participant and storing the input on the pharmaceutical agent in the database; displaying on a display of the computer system, a timeline for the individual participant, summarizing a pharmaceutical history of the individual participant for all pharmaceutical prescriptions and pharmaceutical agents stored in the database; analyzing data in the database, using a processor of the computer system, wherein on condition that the pharmaceutical agent is one of said plurality of pharmaceutical agents, and on condition that the individual participant is one of the plurality of participants, determining a clinical appropriateness of the pharmaceutical agent for the individual participant; displaying, on a display of the computer system, default data from the database on the pharmaceutical agent, to complete standardized data fields on the pharmaceutical agent for the individual participant; and verifying that the completed data fields on the pharmaceutical agent for the individual participant are consistent with industry standards and clinical guidelines; and at least one processor which executes the program.

In one embodiment, a computer-implemented method of dispensing a pharmaceutical, includes: receiving data on a pharmaceutical agent to be dispensed in a database of a computer system; requiring mandatory recording of a quantity of the pharmaceutical agent to be dispensed, at a time of dispersal, in the database; correlating data on the pharmaceutical agent being dispensed, with a quantity in inventory and information on the pharmaceutical agent in the database; verifying quantity and identify of the dispersed pharmaceutical agent at the time of dispersal, with the quantity and information on the pharmaceutical agent in the database; and sending an alert using electronic means, to predetermined parties, on condition that the quantity or the identity of the dispersed pharmaceutical agent is not verified at dispersal.

Thus has been outlined, some features consistent with the present invention in order that the detailed description thereof that follows may be better understood, and in order that the present contribution to the art may be better appreciated. There are, of course, additional features consistent with the present invention that will be described below and which will form the subject matter of the claims appended hereto.

In this respect, before explaining at least one embodiment consistent with the present invention in detail, it is to be understood that the invention is not limited in its application to the details of construction and to the arrangements of the components set forth in the following description or illustrated in the drawings. Methods and apparatuses consistent with the present invention are capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the methods and apparatuses consistent with the present invention.

### BRIEF DESCRIPTION OF THE DRAWINGS

FIG. 1 is schematic environment of a computer system according to one embodiment consistent with the present invention.

FIG. 2 is a flow chart showing the program specifics of the end-user registration and pharmaceutical registration, according to one embodiment consistent with the present invention.

FIG. 3 is a flow chart showing the program specifics of the pharmaceutical dispersal, according to one embodiment consistent with the present invention.

FIG. 4 is a flow chart showing the program specifics of pharmaceutical registration and administration by a patient, according to one embodiment consistent with the present invention.

### DESCRIPTION OF THE INVENTION

The present invention relates to creating an all-inclusive methodology for data collection and analysis which can serve as a vehicle for pharmaceutical meta-analysis and creation of data-driven best practice guidelines, which represents the cornerstone of evidence based medicine (EBM). The present invention includes a number of unique components which record standardized data throughout a multi-step and multi-stakeholder process, with the end result of creating a standardized method for creating, collecting, storing, communicating, and analyzing data related to the multi-step process of pharmaceutical administration in healthcare. In the course of doing so, a number of unique profiles are created which account for patient and provider differences, which are important to identifying compliance risk factors, causation, intervention, and treatment strategies.

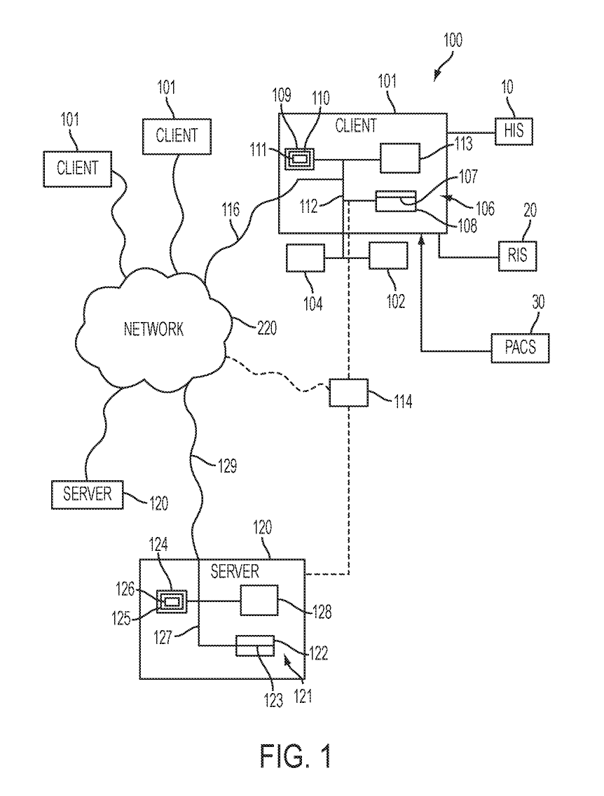

The present invention relates to a number of individual applications which can exist in isolation or combination with one another, According to one embodiment of the invention illustrated in FIG. 1, medical applications may be implemented using the system 100 of the present invention. The system 100 is designed to interface with existing information systems such as a Hospital Information System (HIS) 10, a Radiology Information System (RIS) 20, and/or other information systems, a Picture Archiving and Communication System (PACS) 30, inventory system 31, and/or other systems. The system 100 may be designed to conform with the relevant standards, such as the Digital Imaging and Communications in Medicine (DICOM) standard, DICOM Structured Reporting (SR) standard, and/or the Radiological Society of North America's Integrating the Healthcare Enterprise (IHE) initiative, among other standards.

According to one embodiment, bi-directional communication between the scorecard system 100 of the present invention and the information systems, such as the HIS 10, RIS 20, PACS 30, inventory system 31, etc., may be enabled to allow the scorecard system 100 to retrieve and/or provide information from/to these systems. According to one embodiment of the invention, bi-directional communication between the scorecard system 100 of the present invention and the information systems allows the scorecard system 100 to update information that is stored on the information systems. According to one embodiment of the invention, bi-directional communication between the scorecard system 100 of the present invention and the information systems allows the scorecard system 100 to generate desired reports and/or other information.

The system 100 of the present invention includes a client computer 101, such as a personal computer (PC), which may or may not be interfaced or integrated with the PACS 30. The client computer 101 may include an imaging display device 102 that is capable of providing high resolution digital images in 2-D or 3-D, for example. According to one embodiment of the invention, the client computer 101 may be a mobile terminal if the image resolution is sufficiently high. Mobile terminals may include mobile computing devices, a mobile data organizer (PDA), or other mobile terminals that are operated by the user accessing the program 110 remotely.

According to one embodiment of the invention, an input device 104 or other selection device, may be provided to select hot clickable icons, selection buttons, and/or other selectors that may be displayed in a user interface using a menu, a dialog box, a roll-down window, or other user interface. The user interface may be displayed on the client computer 101. According to one embodiment of the invention, users may input commands to a user interface through a programmable stylus, keyboard, mouse, speech processing device, laser pointer, touch screen, or other input device 104.

According to one embodiment of the invention, the input or other selection device 104 may be implemented by a dedicated piece of hardware or its functions may be executed by code instructions that are executed on the client processor 106. For example, the input or other selection device 104 may be implemented using the imaging display device 102 to display the selection window with a stylus or keyboard for entering a selection.

According to another embodiment of the invention, symbols and/or icons may be entered and/or selected using an input device 104, such as a multi-functional programmable stylus. The multi-functional programmable stylus 104 may be used to draw symbols onto the image and may be used to accomplish other tasks that are intrinsic to the image display, navigation, interpretation, and reporting processes. The multi-functional programmable stylus 104 may provide superior functionality compared to traditional computer keyboard or mouse input devices. According to one embodiment of the invention, the multi-functional programmable stylus also may provide superior functionality within the PACS and Electronic Medical Report (EMR).

According to one embodiment of the invention, the client computer 101 may include a processor 106 that provides client data processing. According to one embodiment of the invention, the processor 106 may include a central processing unit (CPU) 107, a parallel processor, an input/output (I/O) interface 108, a memory 109 with a program 110 having a data structure 111, and/or other components. According to one embodiment of the invention, the components all may be connected by a bus 112. Further, the client computer 101 may include the input device 104, the image display device 102, and one or more secondary storage devices 113. According to one embodiment of the invention, the bus 112 may be internal to the client computer 101 and may include an adapter that enables interfacing with a keyboard or other input device 104. Alternatively, the bus 112 may be located external to the client computer 101.

According to one embodiment of the invention, the image display device 102 may be a high resolution touch screen computer monitor. According to one embodiment of the invention, the image display device 102 may clearly, easily and accurately display images, such as x-rays, and/or other images. Alternatively, the image display device 102 may be implemented using other touch sensitive devices including tablet personal computers, pocket personal computers, plasma screens, among other touch sensitive devices. The touch sensitive devices may include a pressure sensitive screen that is responsive to input from the input device 104, such as a stylus, that may be used to write/draw directly onto the image display device 102.

According to another embodiment of the invention, high resolution goggles may be used as a graphical display to provide end users with the ability to review images. According to another embodiment of the invention, the high resolution goggles may provide graphical display without imposing physical constraints of an external computer.

According to another embodiment, the invention may be implemented by an application that resides on the client computer 101, wherein the client application may be written to run on existing computer operating systems. Users may interact with the application through a graphical user interface. The client application may be ported to other personal computer (PC) software, personal digital assistants (PDAs), cell phones, and/or any other digital device that includes a graphical user interface and appropriate storage capability.

According to one embodiment of the invention, the processor 106 may be internal or external to the client computer 101. According to one embodiment of the invention, the processor 106 may execute a program 110 that is configured to perform predetermined operations. According to one embodiment of the invention, the processor 106 may access the memory 109 in which may be stored at least one sequence of code instructions that may include the program 110 and the data structure 111 for performing predetermined operations. The memory 109 and the program 110 may be located within the client computer 101 or external thereto.

While the system of the present invention may be described as performing certain functions, one of ordinary skill in the art will readily understand that the program 110 may perform the function rather than the entity of the system itself.

According to one embodiment of the invention, the program 110 that runs the QA scorecard system 100 may include separate programs 110 having code that performs desired operations. According to one embodiment of the invention, the program 110 that runs the scorecard system 100 may include a plurality of modules that perform sub-operations of an operation, or may be part of a single module of a larger program 110 that provides the operation.

According to one embodiment of the invention, the processor 106 may be adapted to access and/or execute a plurality of programs 110 that correspond to a plurality of operations. Operations rendered by the program 110 may include, for example, supporting the user interface, providing communication capabilities, performing data mining functions, performing e-mail operations, and/or performing other operations.

According to one embodiment of the invention, the data structure 111 may include a plurality of entries. According to one embodiment of the invention, each entry may include at least a first storage area, or header, that stores the databases or libraries of the image files, for example.

According to one embodiment of the invention, the storage device 113 may store at least one data file, such as image files, text files, data files, audio files, video files, among other file types. According to one embodiment of the invention, the data storage device 113 may include a database, such as a centralized database and/or a distributed database that are connected via a network. According to one embodiment of the invention, the databases may be computer searchable databases. According to one embodiment of the invention, the databases may be relational databases. The data storage device 113 may be coupled to the server 120 and/or the client computer 101, either directly or indirectly through a communication network, such as a LAN, WAN, and/or other networks. The data storage device 113 may be an internal storage device. According to one embodiment of the invention, scorecard system 100 may include an external storage device 114. According to one embodiment of the invention, data may be received via a network and directly processed.

According to one embodiment of the invention, the client computer 101 may be coupled to other client computers 101 or servers 120. According to one embodiment of the invention, the client computer 101 may access administration systems, billing systems and/or other systems, via a communication link 116. According to one embodiment of the invention, the communication link 116 may include a wired and/or wireless communication link, a switched circuit communication link, or may include a network of data processing devices such as a LAN, WAN, the Internet, or combinations thereof. According to one embodiment of the invention, the communication link 116 may couple e-mail systems, fax systems, telephone systems, wireless communications systems such as pagers and cell phones, wireless PDA's and other communication systems.

According to one embodiment of the invention, the communication link 116 may be an adapter unit that is capable of executing various communication protocols in order to establish and maintain communication with the server 120, for example. According to one embodiment of the invention, the communication link 116 may be implemented using a specialized piece of hardware or may be implemented using a general CPU that executes instructions from program 110. According to one embodiment of the invention, the communication link 116 may be at least partially included in the processor 106 that executes instructions from program 110.

According to one embodiment of the invention, if the server 120 is provided in a centralized environment, the server 120 may include a processor 121 having a CPU 122 or parallel processor, which may be a server data processing device and an I/O interface 123. Alternatively, a distributed CPU 122 may be provided that includes a plurality of individual processors 121, which may be located on one or more machines. According to one embodiment of the invention, the processor 121 may be a general data processing unit and may include a data processing unit with large resources (i.e., high processing capabilities and a large memory for storing large amounts of data).

According to one embodiment of the invention, the server 120 also may include a memory 124 having a program 125 that includes a data structure 126, wherein the memory 124 and the associated components all may be connected through bus 127. If the server 120 is implemented by a distributed system, the bus 127 or similar connection line may be implemented using external connections. The server processor 121 may have access to a storage device 128 for storing preferably large numbers of programs 110 for providing various operations to the users.

According to one embodiment of the invention, the data structure 126 may include a plurality of entries, wherein the entries include at least a first storage area that stores image files. Alternatively, the data structure 126 may include entries that are associated with other stored information as one of ordinary skill in the art would appreciate.

According to one embodiment of the invention, the server 120 may include a single unit or may include a distributed system having a plurality of servers 120 or data processing units. The server(s) 120 may be shared by multiple users in direct or indirect connection to each other. The server(s) 120 may be coupled to a communication link 129 that is preferably adapted to communicate with a plurality of client computers 101.

According to one embodiment, the present invention may be implemented using software applications that reside in a client and/or server environment. According to another embodiment, the present invention may be implemented using software applications that reside in a distributed system over a computerized network and across a number of client computer systems. Thus, in the present invention, a particular operation may be performed either at the client computer 101, the server 120, or both.

According to one embodiment of the invention, in a client-server environment, at least one client and at least one server are each coupled to a network 220, such as a Local Area Network (LAN), Wide Area Network (WAN), and/or the Internet, over a communication link 116, 129. Further, even though the systems corresponding to the HIS 10, the RIS 20, and the PACS 30 (if separate), or inventory system 31, are shown as directly coupled to the client computer 101, it is known that these systems may be indirectly coupled to the client over a LAN, WAN, the Internet, and/or other network via communication links. According to one embodiment of the invention, users may access the various information sources through secure and/or non-secure internet connectivity. Thus, operations consistent with the present invention may be carried out at the client computer 101, at the server 120, or both. The server 120, if used, may be accessible by the client computer 101 over the Internet, for example, using a browser application or other interface.

According to one embodiment of the invention, the client computer 101 may enable communications via a wireless service connection. The server 120 may include communications with network/security features, via a wireless server, which connects to, for example, voice recognition. According to one embodiment, user interfaces may be provided that support several interfaces including display screens, voice recognition systems, speakers, microphones, input buttons, and/or other interfaces. According to one embodiment of the invention, select functions may be implemented through the client computer 101 by positioning the input device 104 over selected icons. According to another embodiment of the invention, select functions may be implemented through the client computer 101 using a voice recognition system to enable hands-free operation. One of ordinary skill in the art will recognize that other user interfaces may be provided.

According to another embodiment of the invention, the client computer 101 may be a basic system and the server 120 may include all of the components that are necessary to support the software platform. Further, the present client-server system may be arranged such that the client computer 101 may operate independently of the server 120, but the server 120 may be optionally connected. In the former situation, additional modules may be connected to the client computer 101. In another embodiment consistent with the present invention, the client computer 101 and server 120 may be disposed in one system, rather being separated into two systems.

Although the above physical architecture has been described as client-side or server-side components, one of ordinary skill in the art will appreciate that the components of the physical architecture may be located in either client or server, or in a distributed environment.

Further, although the above-described features and processing operations may be realized by dedicated hardware, or may be realized as programs having code instructions that are executed on data processing units, it is further possible that parts of the above sequence of operations may be carried out in hardware, whereas other of the above processing operations may be carried out using software.

The underlying technology allows for replication to various other sites. Each new site may maintain communication with its neighbors so that in the event of a catastrophic failure, one or more servers 120 may continue to keep the applications running, and allow the system to load-balance the application geographically as required.

Further, although aspects of one implementation of the invention are described as being stored in memory, one of ordinary skill in the art will appreciate that all or part of the invention may be stored on or read from other computer-readable media, such as secondary storage devices, like hard disks, floppy disks, CD-ROM, a carrier wave received from a network such as the Internet, or other forms of ROM or RAM either currently known or later developed. Further, although specific components of the system have been described, one skilled in the art will appreciate that the system suitable for use with the methods and systems of the present invention may contain additional or different components.

The present invention captures and analyzes real-time data at the point of care, and prospectively intervenes in the event that an expected action failed to occur or an adverse action was to occur. The program-derived analytics serve as an objective tool for quantitative accountability, with the goal of improving healthcare outcomes through improved education, communication, compliance, and technology utilization.

While the present invention is described herein with respect to one embodiment directed mainly to pharmaceutical administration (which is an important determinant of patient compliance), there are other embodiments which are encompassed by the steps and associated data recordation and analyzation of the program of the present invention. During the course of each individual step, standardized time-stamped data is recorded buy the program, which provides a permanent record of events, participants, technologies in use, and tasks being performed.

In one embodiment, there are 10 steps and/or program specifics in the analysis of pharmaceutical administration of the present invention. They generally include: 1) End-User Registration; 2) Pharmaceutical Registration; 3) Pharmaceutical Dispersal; 4) Automated Notification; 5) Provider-Patient Communication; 6) Pharmaceutical Administration; 7) Biomarker Verification and Pharmaceutical Inventory; 8) Data Analysis; 9) Automated Feedback; and 10) Intervention and Follow-Up.

End-Use Registration

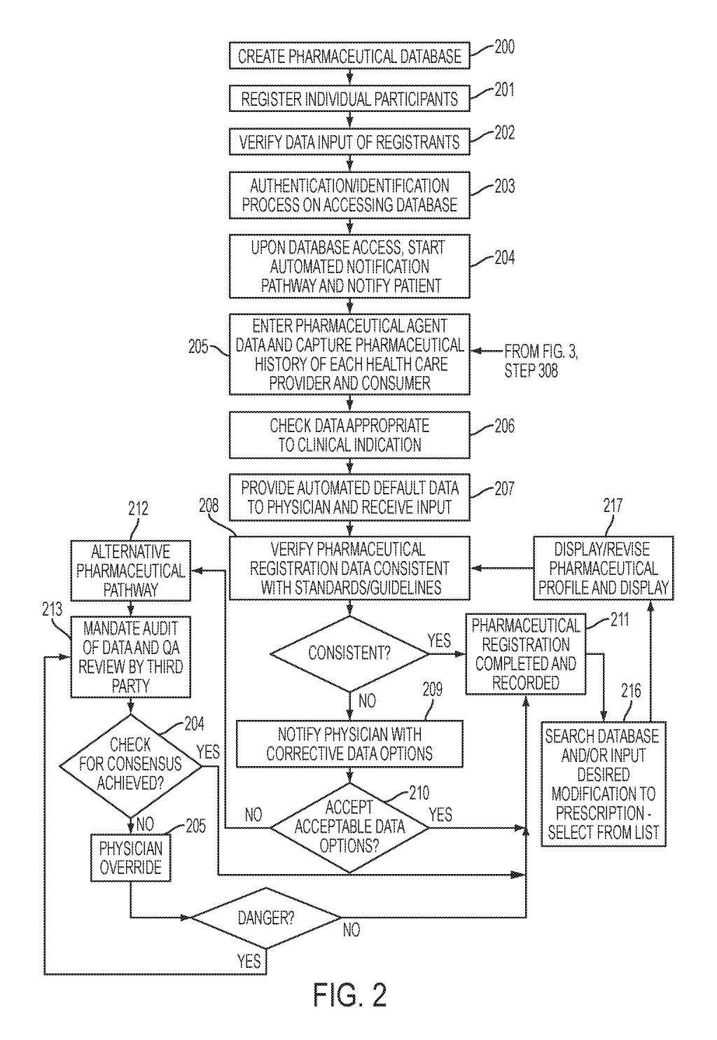

With respect to the first program specific, End-User Registration, in one embodiment, the program 110 of the present invention creates a standardized and referenceable pharmaceutical database 113, 114, and tracks a series of individual data elements related to pharmaceutical administration, taking into account individual participants, pharmaceutical agents, technologies in use, and clinical conditions (i.e., disease states). The first step in the process of creating such a standardized database 113,114 (step 200, FIG. 2) lies in the process of registration for both the individual participants (i.e., patient, caretaker, prescribing physician, pharmacist, nurse, pharmaceutical company) (step 201), and the pharmaceutical agents (step—_(discussed below).

Participant (i.e., end-user) registration includes a standardized process of end-user identification and authentication, so that any time an individual end-user participates in pharmaceutical administration (regardless of the individual patient, pharmaceutical agent, or geographic location), a digital record will be created by the program 110 which identifies the end-user, provides a rapid method for validation and authentication of their role in the process of pharmaceutical delivery, provides a digital record of their actions, and creates a tool for customized decision support.

In one embodiment, at the time of end-user registration, a number of standardized data would be recorded (step 201) and verified (step 202) by the program 110 for entry into the pharmaceutical database 113,114 which includes a combination of demographic, occupational, education, training, licensing, credentialing, certification, and medico-legal data. The standardized data within this registration database 113, 114 would provide a consistent mechanism for ensuing that established quality and safety standards related to pharmaceutical administration are maintained.

As noted above, the data input from registrants undergo a verification process in step 202 by the program 110 to ensure data accuracy and completeness, which can take place at the time of initial registration, as well as by performing randomized data audits thereafter, to ensure ongoing data accuracy throughout the course of individual end-user experience with pharmaceutical administration.

In one embodiment, on the most simplistic level this verification step 202 could include program 110 review of the licensing and credentialing of an individual physician to ensure that he/she is properly licensed in the state of record, is authorized to prescribe the pharmaceutical being ordered (e.g., controlled substances), and is properly credentialed within the patient's healthcare network (if network restrictions exist).

In one embodiment, similar electronic registration processes would also be performed by the program 110 on other healthcare providers (e.g., pharmacist, nurse) and consumers (e.g., caretaker, patient). While the pharmaceutical registration database 113, 114 is primarily designed for the program 110 to record and analyze data with respect to the principal parties involved in pharmaceutical administration, other data analyses by the program 110 may prove beneficial to other interested parties (e.g., healthcare researchers, information technology professionals, third party payers, pharmaceutical companies).

All persons accessing or inputting data to/from this database 113, 114 would be expected to undergo this formal registration process (step 201) to ensure that data quality and safety standards are maintained.

In one embodiment, in addition to the patient, who is the primary participant in this first step 201, other participants play important roles including the physician (or other designated healthcare provider) prescribing the pharmaceutical of record, clerical staff, information system technology professionals, the pharmacist tasked with filling the prescription, the nurse and/or caretaker who may assist in drug administration along with the patient who is being treated. Since each of these participants play some role in the overall success (or failure) of pharmaceutical administration, it is important that user-specific data be defined and analyzed for the program 110 creation of customizable interventional strategies for improved healthcare outcomes.

In one embodiment, the standardized method of end-user electronic registration (step 201) for the pharmaceutical database 113, 114 could be performed in a variety of ways including biometrics, speech analysis, and unique data identifiers. If biometrics (e.g., fingerprint, retinal scan) are used, they could be directly integrated by the program 110 into a number of computerized technologies which can improve workflow, reduce data input error, and facilitate timely and accurate access to the standardized database 113, 114.

As noted above, in one embodiment, once the formal registration process (steps 201-202) has been completed, and the individual participant's data is accessible within the database 113, 114, a simple authentication/identification process would take place (e.g., fingerprint scan) (step 203) each time that individual attempts to access the pharmaceutical database 113, 114; whether it be for recording new data, historical data review, longitudinal data analysis, or computerized decision support. This provides a date- and time-stamped record of each end-user's activity; which can be sorted and analyzed by the program 110 in accordance with the individual pharmaceutical agent, geographic location, patient, and clinical circumstances.

In one embodiment, each time the pharmaceutical database 113, 114 of an individual patient is attempted and/or successfully accessed by the program 110 based on an inquiry, an automated notification pathway can be triggered by the program 110 in step 204, which serves to notify the corresponding patient of the date, time, identity, and specific data being reviewed from their personal medical record. This provides an up-to-date record of pharmaceutical data access, while also providing the individual patient or their designated caretaker with the ability to modify individual healthcare professionals' data access to their medical records.

In particular, in one embodiment, electronic auditing tools can be integrated into the technology to continually access how data is being accessed and acted upon by individual healthcare professionals. This knowledge can in turn be used by the program 110 to create customized context specific end-user data retrieval templates, as recurrent data patterns are established. This can in effect, automate the process of data retrieval while also providing context for creation of automated decision support tools in accordance with individual end-user data usage patterns.

Pharmaceutical Registration

In one embodiment, with respect to the second program specific, on each occasion when a formal action on a pharmaceutical agent takes place, a Pharmaceutical Registration process is required in step 205, similar to that of the End-Users Registration above, but specific to the individual pharmaceutical agent. This could include ordering a new prescription, refill of an existing prescription, making a change to a current pharmaceutical order (e.g., alteration in dosage), or pharmaceutical discontinuation/termination.

In one embodiment, the purpose of the pharmaceutical registration process is to consistently capture in step 205, all data related to the pharmaceutical, and the pharmaceutical history of each individual healthcare provider and consumer. By standardized the data which is prospectively recorded, the program 110 creates a method for longitudinal pharmaceutical data analysis which can be used for a variety of applications including (but not limited to) real-time decision support, clinical and economic analyses, creation of best practice standards, and personalized medicine (i.e., customized to specific patient attributes).

In one embodiment, the individual component data captured in step 205 of the Pharmaceutical Registration includes the: name of the Pharmaceutical Agent; the manufacturer;

the method of administration; the dosage; the frequency; the duration of taking the Pharmaceutical; the number of refills; the clinical indication; clinical data (may be color coded); contraindications and warnings; adverse reactions; drug interactions; required testing; expiration date; customized pharmaceutical tagging schema; manufacturing recommendations; FDA guidelines; identities of participating stakeholders; and automated notification pathway.

In one embodiment, the Pharmaceutical Registration may be easily modified and updated in accordance with existing industry wide and healthcare standards (e.g., U.S. Pharmacopeial Standards, National Formulary, U.S. Food and Drug Administration, International Organization for Standardization, World Health Organization). Both manual and automated modes of data input would be supported by the invention.

In one embodiment, in manual operation, the ordering physician would enter, in step 205, the name of the pharmaceutical agent of interest, dosage, frequency, and clinical indication, etc. (i.e., in an analogous method to current electronic medical practice).

The pharmaceutical agent database 113, 114 could then be automatically queried such that the program 110 can make an analysis in step 206, to ensure that the inputted data is appropriate for the given clinical indication. The program 110 will then proceed to provide the physician with automated default data in step 207, to complete the required standardized data fields. The physician can elect to accept the default data as presented or manually modify the data in accordance with his/her clinical requirements.

In one embodiment, after completion of data input (through either manual or automated methods) in steps 205-207, artificial intelligence techniques (e.g., neural networks) used by the program 110 in step 208, will verify that the pharmaceutical registration data is consistent with industry wide standards and established practice guidelines. In the event that any of the data is deemed to be outside the scope of accepted clinical practice, the program 110 will issue an automated prompt which will notify the physician in step 209, of the discrepancy along with alternative/corrective data options which would satisfy existing practice standards. If the ordering physician was to elect to accept one of the program-derived “acceptable” data options in step 210, then the pharmaceutical registration process would be completed with the approved modifications in step 211. If on the other hand, the physician elects not to accept the program-derived recommendations, an “alternative” pharmaceutical pathway would be activated by the program in step 212.

In one embodiment, activation of an “alternative” pathway would mandate an audit of the data along with a quality assurance review in step 213, by an established third party expert (e.g., pharmacologist, subspecialty physician), with the option for formal consultation. If consensus between the parties is successfully achieved, the modified data would be recorded by the program 110 in the pharmaceutical registration database 113, 114, completing registration in step 211, with the corresponding details of the audit (e.g. date-time, identities of the individuals, initial data discrepancy, finalized data modifications).

In one embodiment, the program 110 checks that consensus is achieved in step 214, and if consensus is not achieved, the ordering physician can override the process and retain the right to complete the registration process in step 215 in the manner he/she believes is in the patient's best clinical interest (with the identified data concerns recorded in the database 113, 114 by the program 110 for future review and/or analysis).

In one embodiment, in the event that a finalized order was determined by the program 110 to fall outside of established clinical guidelines and constituted a clinical danger to the patient (e.g., adverse drug interaction, high risk for organ toxicity), then a formal review by an expert third party and consensus may be required by the program 110 (back to step 213) before the order is accepted and registration completed in step 211.

In one exemplary embodiment, in the event that an existing prescription is being altered or cancelled, the physician can simply access the individual patient's pharmaceutical records from the database 113, 114, as noted in step 204, and highlight the specific pharmaceutical agent of interest. Once this is done, he/she can input the desired modification (or select from a list of computerized options provided by the program 110), in step 215. The program 110 will revise the pharmaceutical data profile of the patient, and show the revised profile on the display 102 for the physician's final review and acceptance in step 216.

Once this has been completed, in one embodiment, the patient's pharmaceutical profile will reflect the new revision, which includes the changes made, date/time of the event, identifications of involved parties, and supporting clinical data (which can be input at the discretion of the ordering physician). Just as was the case with a new pharmaceutical order, any adjustment requested which is inconsistent with established standards, as determined by step 208, will prompt the program 110 to follow step 209 and generate an audit and quality assurance review (i.e., step 213) prior to finalization in step 211.

In one embodiment, each time a modification is made to an individual patient's pharmaceutical data as in step 217, an automated update in their pharmaceutical summary record is made by the program 110 which includes the following information: a) identity of the healthcare professional; b) location in which the action is taken; c) date and time of the action; d) name and dosage of the pharmaceutical of interest; e) clinical indication warranting therapy; f) specific pharmaceutical action taken (e.g., discontinuation, renewal, modification of dose, change to alternative medication); and g) associated clinical metrics (e.g., lab data, physical examination data, drug levels).

In one embodiment, this standardized data in turn is directly linked by the program 110 to the specific pharmaceutical event and can be displayed by the program 110 on the display in step 217 in a graphical timeline which summarizes the pharmaceutical history of the individual patient for all pharmaceutical prescriptions. In one embodiment, when an authorized end-user reviews this graphical pharmaceutical timeline, he/she can highlight any point on the timeline and be presented by the program 110 with the aforementioned data points specific to that drug action taken. The display presentation of this timeline in step 217 can be customized to the specific needs of the authorized end-user by the program 110, while also providing the ability to display individual or grouped pharmaceuticals specific to individual disease states and/or organ systems.

In one exemplary embodiment, if for example, a cardiologist wants to search the patient's pharmaceutical history specific to a specific pharmaceutical class (e.g., anti-hypertensives), he can input the clinical indication and/or drug category into the system 100 in step 216, and the program 110 derived timeline would display only those pharmaceuticals which fulfill the specific search criteria in step 217. At the same time, the cardiologist could narrow the search to specific data points (e.g., defined period of time, introduction of new pharmaceutical agents, decisions attributable to a specific healthcare provider, etc.). Thus, the program 110 of the present invention creates a standardized method of graphical display which can easily be searched and modified in accordance with the individual end-user's clinical needs, while also providing customization features for the manner in which the data is displayed and presented for review and analysis by the program 100.

Pharmaceutical Dispersal

The third program specific in the standardized registration process is Pharmaceutical Dispersal, which takes place with the filling (i.e., dispersal) of the ordered pharmaceutical agent, which is customarily performed by a licensed pharmacist. In one embodiment of this dispensation step, the healthcare professional responsible for fulfilling the successfully completed pharmaceutical order would first undergo successful authentication/identification (to ensure they have the appropriate licensing and credentials for the task being performed) as in steps 202-203, followed by registration of the pharmaceutical agent being dispensed to the patient in step 211.

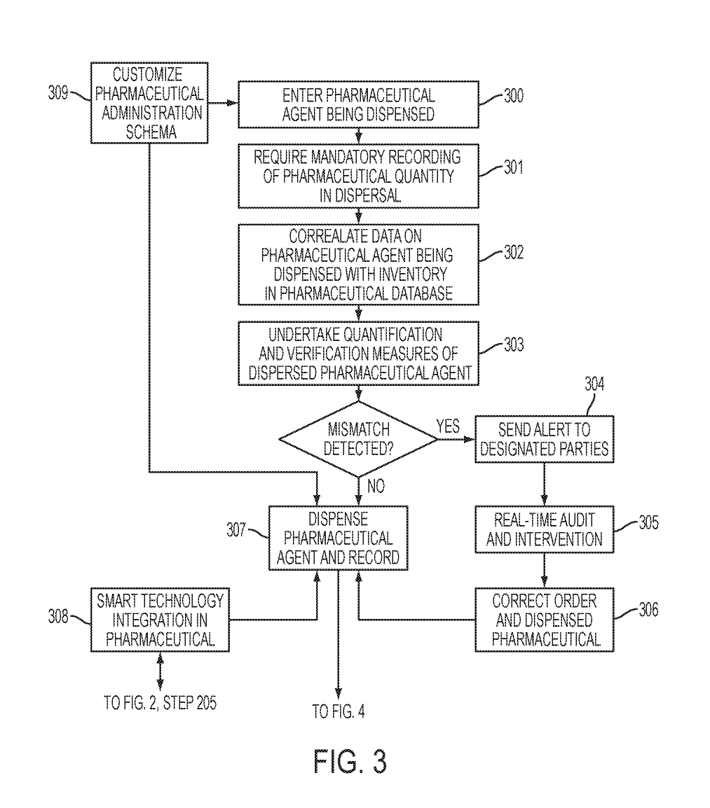

In one embodiment of this dispersal process, the specific pharmaceutical agent being dispensed to the patient, along with number of refills, quantity, manufacturer, dosage, frequency, duration, mode of administration, potential side effects, instructions for administration, and clinical indication, are inputted into the system 100, in step 300 (see FIG. 3). While some of this data (e.g., side effects, adverse drug interactions, instructions for administration) can be automatically retrieved and populated within the pharmaceutical database 113, 114 from the Pharmaceutical Registration step above (step 207), certain data elements require mandatory data input by the licensed individual tasked with dispersal (e.g., pharmaceutical agent, manufacturer, dosage, quantity) in step 300.

In one embodiment of this dispersal process, both manual and automated methods for data entry can be utilized. Manual data entry requires direct input of data from the end-user by the program 110, and is specifically identified in the database 113, 114 as “manual data entry”, for future data auditing and/or analysis. Automated data entry in the dispensation process can incorporate the use by the program 100, of embedded biomarkers within the pharmaceutical agents (which are incorporated by the pharmaceutical manufacturer) which store standardized data related to the specific pharmaceutical agent, such as manufacturer, lot number, date/time of manufacture, quality assurance testing (e.g., drug purity), and expiration date.

In one embodiment, the advantage of automated data entry is that it removes the potential for human (inadvertent) data entry error, reduces erroneous data entry (either deliberate or non-deliberate), records data specifically provided by the pharmaceutical source (i.e., at the point of manufacture), and ensures that all recorded data by the program 110 is standardized and uniform.

Since an integral part of the dispersal process is related to quantity (i.e., how many individual pharmaceutical doses are contained within the prescription being filled), it is important that accurate and verifiable data be recorded by the program 110 into the database 113, 114. In conventional practice, a pharmacist will manually count the number of doses (e.g., tablets, ounces) being supplied in the prescription order being filled and record this data on the label of the pharmaceutical receptacle. Since this data is not conventionally manually recorded in a database, it is essentially “untrackable” and goes undetected. This dispersal error can be the result of either non-deliberate or deliberate error, the latter of which constitutes fraudulent activity. For controlled substances, this is a particularly troublesome problem since accurate record keeping is imperative to account for illegal activity.

Thus, creating a system which requires mandatory recording of pharmaceutical quantity in dispersal in step 301, creates a valuable method for tracking inventory at the levels of the patient, individual healthcare provider, and institutional provider. In one embodiment, while manual data entry is still subject to the possibility of erroneous data entry, this can be effectively circumvented by automated data entry relating to drug quantity in step 301, using the program 110 of the present invention. In one embodiment, an automated method for recording pharmaceutical quantification using the present program 110, creates a reliable and effective method for correctly identifying the quantity of a given pharmaceutical being dispensed in the prescription order and correlating this data with the specific pharmaceutical agent inventory (i.e., quantification of pre- and post-prescription inventory for a specific pharmaceutical agent) in step 302.

In one exemplary embodiment, a recorded prescription order is for 30 tablets of a given pharmaceutical, and the following data is recorded by the program 110 in the pharmaceutical database 113, 114, in step 301, to ensure compliance and accuracy of the dispensation process: a) pharmaceutical agent identification and dosage; b) quantity of pharmaceutical agent in the prescribed order; c) quantity of pharmaceutical agent in the pharmacy inventory prior to dispersal; d) quantity of pharmaceutical agent in the pharmacy inventory after dispersal; e) identity of the person dispensing the pharmaceutical order; f) date and time of pharmaceutical dispersal; and g) identity of the patient receiving the pharmaceutical order.

In one embodiment, in each step of this process, date- and time-stamped data related to the pharmaceutical agent and provider (i.e., pharmacist) are recorded by the program 110 to ensure compliance with the prescribed order and ensure that no unexplained inventory loss took place in step 302. The simplest way in which inventory can be measured and recorded by the program 110 in the database 113, 114 would be to utilize embedded biomarkers to record the identity and dosage of the pharmaceutical agent and then create a physical record of the quantity being filled in step 301, through physical attributes of the pharmaceutical agent (e.g., size, shape, texture, weight, color).

In one embodiment, depending upon the concern for error and/or fraudulent activity, quantification measurements can be performed in individual or collective fashion in step 303. Examples of where pharmaceutical agents are required by the program 110 to be recorded on an individual basis (i.e., each individual tablet recorded), in step 303, include: controlled substances; individual patients with history of noncompliance and/or abuse; and providers with previously documented errors which require more intensive monitoring. For the majority of the remaining cases, the prescription orders can be recorded as a collective lot, where one dose is individually recorded by the program 110 in order to document and verify the physical attributes of the pharmaceutical agent, while the others are analyzed by the program 110 as a collective group.

In one exemplary embodiment, a single tablet is first verified in step 303, through biomarker data analysis and determined to weigh 1.5 grams, have a color of yellow, have the shape of oval, and length/width measurements of 8 and 3 mm respectively. Knowing the prescription order calls for 30 individual tablets, the total weight would be expected to be 45 grams, and a photographic analysis of the collective group by the program 110 in step 303, would require uniform consistency in the correct color, shape, and dimensions. The ability of the program 110 to incorporate photographic images of each individual pharmaceutical (as well as the collective lot), provides an important quality assurance strategy for ensuring dispersal compliance. The obtained photographic images can be electronically cross-referenced by the program 110 with an established pharmaceutical photographic database 113, 114. In the event that the program 110 determined there was a “mismatch’ when the data was recorded in the database 113, 114, an automated alert could be automatically sent by the program 110 to the end-user (e.g., acting pharmacist) and other designated parties (e.g., department chief, institutional compliance officer, governmental agency (e.g., Food and Drug Administration) in step 304, for immediate action and intervention in step 305, to ensure the prescribed order and dispersed pharmaceuticals correlate with one another in step 306 before being dispensed in step 307.

As noted above, in another embodiment, an alternative method of pharmaceutical lot quantification could include group analysis of embedded biomarkers by the program 110. Once a single biomarker is recorded in the database 113, 114 by the program 110, a collective analysis of the group biomarkers can be performed by the program 110 to quantify the collective number of embedded biomarkers, along with a verification that all recorded biomarkers are identical to the biomarker of record, in step 302. A variety of methods could be used for collective biomarker quantification including (but not limited to): multi-sensory tracking and reporting identification markers, such as the recording of electronic, visual (color-coded, symbols, alpha-numeric identifications (IDs)), auditory (sound) signals, haptic/tactile (shaped ID), olfactory (smell ID), and taste (i.e., fruit-tasting ID), which are incorporated into the biomarker, which can in turn be analyzed by a corresponding biomarker reader.

One purpose of the pharmaceutical registration and dispersal process of the present invention, is to provide quantitative and qualitative accountability to ensure that all data is prospectively recorded by the program 110 in a standardized format, and that computerized analysis is performed by the program 110 at the point of care to identify potential errors or risks specific to the individual patient or pharmaceutical agent being prescribed; alternative data sources which are available to assist in consultation and decision making,; ensure that data is consistently recorded for longitudinal data analysis; and a quality assurance (QA) system is put into place, such that all data being recorded by the program 110 is accurate and verifiable.

In the event that any concerns for data accuracy or compliance with established practice guidelines are identified, the program 110 will create an automated pathway for real-time auditing and intervention in step 305, in order to ensure the correct order of the dispensed pharmaceutical 306, before being dispensed in step 307.

Automated Notification and Customization Features

In one embodiment, once the pharmaceutical data registration has been completed (as shown in FIG. 2), a number of customization features can be employed by the program 100 which are specific to the individual patient. The primary purpose of these customization features is to provide the patient (or caretaker) with education, safety, and memory tools to improve pharmaceutical compliance and clinical outcomes.

In one embodiment, one way to accomplish this is to have the program 110 create an automated alert system which provides the patient with customizable prompts and graphical displays related to pharmaceutical administration. While this customizable schema can be created (or modified) by the patient or caretaker at any time in step 309, it can be established at either the time of pharmaceutical ordering (with assistance by the ordering physician or designated staff) (step 300) or pharmaceutical dispersal (with assistance by the pharmacist or designated staff) (step 307).

In either of these events, it is customary for the healthcare provider (i.e., physician or pharmacist) to consult with the patient regarding the pharmaceutical being ordered along with instructions related to how it is to be taken, potential complications or side effects, and potential drug interactions. In conventional practice, these instructions are performed verbally and reinforced by written data attached to the prescription. The problem with this conventional approach is that patients (or their caretakers) often forget the verbal information required and physically separate the written data from the pharmaceutical agent. This “disconnect” between the pharmaceutical and corresponding safety information may frequently lead to a number of adverse consequences including (but not limited to) missed doses, improper dosing, doses administered at the wrong times, non-compliance with administration recommendations (i.e., “do not take in combination with food”, “do not operate vehicles after taking”, etc.), failure to detect and/or act upon safety concerns, failure to fill and/or refill prescriptions in a timely fashion, taking expired medications, or improperly taking “leftover” medications without physician approval and/or consultation.

The solution to these current problems is the creation of the automated system of the present invention, where, in one embodiment, the program 110 records, tracks, and analyzes standardized pharmaceutical data throughout the continuum of patient care, while utilizing easy to understand and personalized communication tools to increase compliance, pharmaceutical safety, and clinical outcomes.

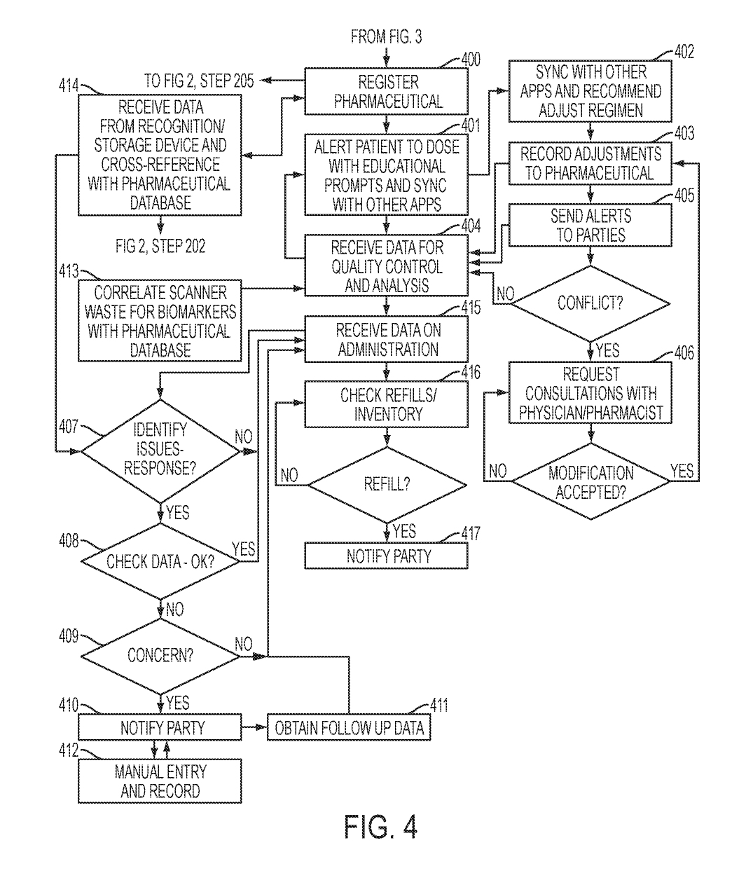

Traditional provider/patient verbal communications would be supplemented by customized educational prompts provided to the patient or caretaker by the program 110, at the designated times of pharmaceutical dosing schedules (step 401, FIG. 4). These educational prompts would contain standard information relating to pharmaceutical safety and administration (i.e., “do not take on empty stomach”, “medication may cause drowsiness”, etc.), which may be customized based upon individual patient habits and preferences.

As an example, the standard alerts “do not take on empty stomach” and “may cause drowsiness” may be customized by the program 110 to the individual patient's actions and habits to state “take with ½ glass of milk and 2 cookies” and “do not drive for the next 4 hours”. This can be further customized by the program 110 to the specific dosing regimen of the pharmaceutical as well upon patient pharmaceutical registration (step 400, discussed below).

The recommendation for eating/drinking something at the time of dosing may be modified by the program 110 in accordance with the time of day and patient's personal preferences. In the case of a three times a day dosing scheduled at 7 am, 3 pm, and 11 pm, for example, the prompts may be modified by the program 110 as follows:

7 am: take with ½ glass of orange juice and muffin

3 pm: take with ½ glass of water and crackers

11 pm: take with ½ glass of milk and 2 cookies

For example, a diabetic patient may have the dietary prompts customized by the program 110, in accordance with their dietician's recommendation, in order to comply with stricter dietary requirements related to underlying disease. In another example, a patient with hypertension on a low sodium diet may have a specific recommendation linked to low sodium intake. The net result is that the medication-related instructional information (step 401) can be directly tied by the program 110, to each individual patient's clinical condition, personal preferences, and daily habits.

In the same light, in one embodiment, the alert (step 401) tied to medication-related drowsiness may be correlated by the program 110 with the personal habits of the individual patient (when customizing the schema in step 309, FIG. 3). As an example, suppose a patient routinely drives to the grocery store on Tuesday mornings and Friday afternoons. Since the program 110 and its derived alerts (step 401) are date- and time-stamped, a patient's daily and hourly routines can be programmed by the program 110 into the customizable notification system to take into account daily and hourly schedules (which can be established as defaults and regularly updated in accordance with programmed schedules). In this example of routine Tuesday morning and Friday afternoon grocery shopping, the Tuesday 7 am medication alert (step 401) reminds the patient that the medication may cause drowsiness and recommends that if travel is planned for the next 3 hours, they should delegate driving to another party.

In one embodiment, this customizable education/safety feature can also be synched by the program 110 with other electronic applications (e.g., daily schedule) (step 402, FIG. 4), in order to modify dosing regimens and recommendations in accordance with the planned daily activities. As an example, if the patient has a planned business meeting scheduled for 2 pm-4 pm, they would likely miss their scheduled 3 pm dose. As a result, the program 110 could provide a pre-day prompt (step 401) notifying the patient of routine scheduled doses and recommendations for adjustment (step 402) in accordance with the available schedule information.

In this example, the pre-day dosing schedule may be presented by the program in step 402, with the option to change the scheduled 3 pm dose to 1:45 pm to accommodate the scheduled 2 pm-4 pm business meeting. If the patient provides feedback to “accept” the recommended modification, this will now be automatically incorporated by the program 110 into the dosing regimen in step 402, and the new alert (step 401) will be issued by the program 110 in at 1:45 pm instead of the originally scheduled 3:00 pm time. A patient or caretaker always has the prerogative to modify the schedule as needed. Any adjustments to the dosing regimen will automatically be recorded by the program 110 and time-stamped in the pharmaceutical database 113, 114 (step 403). When a longitudinal analysis of the patient and pharmaceutical dosing schedule is reviewed by the program 110 (step 404) and displayed for the user, both the “standard” and “modified” times will be reflected in the numerical and graphical displays.

In one embodiment, when a consistent trend in “modified” day/times is identified in step 404, the program 110 may automatically present the end-user with an option to reconfigure the scheduled dosing regimen (step 401) in accordance with the regularly observed modified regimen. In the event that the patient or caretaker was to “accept” the modified schedule changes, these would now be recorded by the program 110 in the database 113, 114 (step 403), as new standard dosing, and the resulting automated alerts/prompts (step 401) would be changed by the program 110 to reflect the new changes in dosing.

In one embodiment, all modifications to established dosing schema would automatically result in an electronic notification by the program 110 to designated healthcare providers (e.g., prescribing physician, pharmacist) for review (step 405). In the event that a modification in dosing schedule was to result in a potential conflict (e.g., overlap in dosing with another pharmaceutical agent) an alert would be sent by the program 110 requiring physician and/or pharmacist consultation (step 406) before the requested modifications would be accepted and incorporated into the patient's pharmaceutical database 113, 114 (step 403).

In one embodiment, in addition to individual preferences and habits, the customized features of patient feedback, alerts, and education can also take into account other patient/caretaker attributes such as socioeconomic status, education, language preferences, cognitive status, visual acuity, personality, emotional state, clinical status, and healthcare literacy (which collectively can be used to create patient profiles, which will be discussed in detail later).

In one embodiment, in order to illustrate how these patient-specific attributes can be used to create dynamic and customizable alerts, the following example is used.

A 65 year-old Hispanic female presents, who suffers from short term memory loss and is emotionally distraught due to the recent death of a loved one. On the most superficial level, the patient's fluency in Spanish and poor proficiency of English would result in text or voice data communications to be performed in Spanish to improve understanding and compliance. The patient's cognitive impairment in the form of short term memory loss prevents her from accurately recalling the prescribed medication dosing schedule. In one embodiment, the program 110 compensates for this memory impairment by sending more frequent medication alerts (step 401) at 2 hour intervals.

In the same example, since the patient's recent loss of a loved one has resulted in a situational anxiety disorder, in order to compensate for this heightened anxiety, the patient (after consultation with her primary care physician and daughter), has elected to modify the dosing alerts (step 401) to hourly intervals while also changing the notification prompt from that of a ringing sound to one of soft music. In one embodiment, the end-goal is to create a dynamic and customizable tool for providing education and feedback in accordance with each individual patient's needs, preferences, and abilities. By integrating a direct feedback tool into the application in which the patient or caretaker can respond to the alerts/prompts, content can be continuously modified by the program 110 to improve perceived value and individual patient benefit.

Further in the previous example, when an hourly update (step 401) is provided by the program 110 to the patient, she can respond by selecting the program 110 option for a reminder in a predetermined amount of time, i.e., 15 minutes. If the next hourly update was also followed by a request for a 15 minute reminder by the end-user, the program 110 would ask the end-user if she would prefer future updates to occur every 15 minutes.

Alternatively, if the patient found the scheduled hourly updates (step 401) were too intrusive and inputted that the frequency of updates be modified to every two hours, the program 110 would adjust accordingly (step 403). In some situations, the patient may not actively provide feedback but the program 110 can modify content passively, provide a default option, or provide a pathway to determine the seriousness of the lack of feedback information from the end-user.

As an example, if a patient falls asleep and does not issue a response to a prompt (401), the program 110 can record this action as a “non-response”. If a similar non-response is received at the time of the next automated alert or prompt (401), the program 110 now identifies that two consecutive alerts have not been responded to (step 407), which automatically triggers an escalation of the notification pathway by the program 110.

Since a number of causes could be responsible (e.g., patient fell asleep, patient misplaced or lost the technology, patient had an accident or medical emergency which precludes their ability to respond, etc.), the program 110 can determine the best response. By automatically retrieving and analyzing historical data (step 408) specific to the patient, the program 110 can statistically determine the relative odds of each potential case of alert non-responses. In this example, the patient has an established record of frequent “non-responses” and as a result the lack of response is determined by the program 110 to be of probable low concern. If on the other hand, the patient's data analysis by the program 110 reveals that non-responses are rare, a higher priority would be assigned by the program 110 to follow up and escalation (step 409).

In one embodiment, if the program 110 has integrated into it, the collection of real-time physiologic medical data (e.g., heart rate, respirations, blood pressure, glucose, etc.), this provides a remote ability for the program 110 to assess the patient's clinical status and gauge the medical severity of the non-response. Suppose in this example, the patient's respirations went from a routine baseline of 16, to 12, which would be indirect evidence that the patient fell asleep. On the other hand, suppose the patient's respirations went from a baseline of 16 to 22, which would be of far greater concern for a medical emergency. Options for the program 110 to initiate upon analysis of this data (step 409) may include notification (i.e., by electronic methods such as email, text, fax, etc.) of non-response to a designated family member, friend, or healthcare provider (step 410). The ability to integrate global positioning satellite (GPS) technology into the program 110 provides a tracking tool for geographic localization. Once the situation has been rectified, mandated follow-up data is required to be provided to the program 110 (step 411), and received in step 404, in order to ascertain the cause of the non-response, and to adjudicate future actions.

Provider-Patient Communication

In one embodiment, in addition to traditional text or voice modes of communication, alternative communication schema can be employed by the present invention, in accordance with individual patient (or caretaker) profiles. The goal of the present invention is to create a simple and easily comprehended communication schema which can present pharmaceutical data in real-time commensurate with individual patient (or caretaker) communication preferences and abilities.

In one embodiment, a number of multi-sensory data display and communication strategies can be utilized including (but not limited to): data displays in visual format (e.g., color coded displays, graphical symbols and icons, alpha numeric identifiers), sound, smell, touch, and taste. These customized multi-sensory cues could be directly integrated with individual pharmaceuticals (step 309) so that when prompted by the program 110, the patient or caretaker would learn to recognize the specific pharmaceutical of interest based upon the unique sensory cue tied to its identity. This takes on heightened importance for patients taking numerous medications and patients who have cognitive, visual, and/or memory impairment.

In one exemplary embodiment, to illustrate how such a system would be implemented into everyday use, a patient whose prescription for the treatment of high blood pressure is being changed from Drug A to Drug B. In conventional practice, the physician would explain to the patient the reason for changing the medication, provide the patient with a new prescription order, and provide dosing instructions and safety recommendations related to the new drug. The patient would then proceed to the pharmacy, get the new prescription filled (which has dosing instructions and safety recommendations attached in text format), and then take the new medication (drug B) at the prescribed time, while discontinuing the old medication (drug A). In the ideal world, this transition from drug A to B would go as planned, without any adverse consequences. In reality, however, a number of errors could take place related to improper administration of the new medication (drug B), failure to discontinue the old medication (drug A), or failure to recognize new side effects or complications related to the new medication (drug B).

Many of these potential errors could be obviated through the use of the present invention. In one embodiment, when the physician elects to change medications from drug A to drug B, these changes will be recorded by the program 110 in the pharmaceutical database 113, 114 during the initial step of Pharmaceutical Registration (step 211, FIG. 2). Each time a pharmaceutical is being added, deleted, or modified in the course of patient care, the ordering physician is tasked by the program 110 with updating the pharmaceutical database 113, 114 (step 300). In fact, an electronic prescription order (or pharmacist dispersal of the pharmaceutical agent in step 307) cannot be completed until this registration process (FIG. 2) has been satisfactorily completed.

In one embodiment, at the time of pharmaceutical registration (steps 300-307, FIG. 3), the healthcare provider and the patient collectively decide on the preferred pharmaceutical identification and communication schema (step 309), based upon a number of available options and technologies. In this particular example, the patient has poor eyesight, memory deficit, and is technologically challenged. As a result, in this example, the physician and patient choose an identification/communication schema (step 309) based upon color coded graphics and auditory cues which are displayed on an electronic wristband or watch.

In the exemplary embodiment, the new pharmaceutical (drug B) is assigned a specific color, symbol, and sound (step 309) which will automatically be communicated by the program 110, via a communications means (i.e., a wristband device, cell phone, pager, etc.) at the prescribed times of drug B's dosing schedule (step 401, FIG. 4). For this specific pharmaceutical, the patient and physician have chosen any one or more of the color blue, symbol of an ocean wave, and sound of the ocean, for example. Each time the program 110 identifies the dosing schedule of Drug B as being 5 minutes away, an automated communication prompt (step 401) will submitted by the program 110, including, for example, a flashing blue light, followed by the graphic of an ocean wave, and the sound of the ocean.

In one embodiment, a sense of taste could also be incorporated, such as a specific taste (e.g., lemon), which could be applied to the surface of the pharmaceutical (by the pharmacist at the time of dispersal in step 307), and which would also be stored in the pharmaceutical database 113, 114. The patient will learn to recognize these pharmaceutical specific sensory cues associated with drug B, over time, which will hopefully improve compliance and accurate pharmaceutical administration. At the same time, the sensory cues customized for the discontinued pharmaceutical (drug A) are now cancelled by the program 110 (step 402). If for some reason, the patient inadvertently attempts to take drug A after it has been discontinued from the pharmaceutical database 113, 114, an automated warning alert (405) will be communicated by the program 110 to both the patient and physician of record.

Pharmaceutical Administration

Pharmaceutical administration on an outpatient basis is a major determinant of pharmaceutical effectiveness. A number of administration errors can occur which have the potential to adversely affect clinical outcomes including lack of administration, incorrect dosage, improper timing, and failure to comply with instructions (e.g., “do not take on an empty stomach”, “do not take with alcohol”, etc.). Since current practice has no substantive method of outpatient monitoring relating to pharmaceutical administration, compliance is largely left to the discretion of the patient and/or caretaker. If a patient fails to comply with administration instructions, there is little documentation or monitoring capabilities which can trigger prospective intervention. In isolated cases, a physician may order blood tests to determine in vivo levels of a specific pharmaceutical, but this is largely deferred to those pharmaceuticals where optimizing blood levels is essential to determining proper drug dosage (e.g., anticoagulation therapy), or if there is a suspicion for drug overdose and/or toxicity.

In one embodiment, the present invention is used to create a comprehensive and standardized system which provides prospective data collection and analysis for pharmaceutical administration. In one embodiment, the process would incorporate standardized data recorded in the steps of pharmaceutical ordering (by a physician) (step 300) and dispersal (by a pharmacist) (step 307). In one embodiment, at the time of these steps, data related to the specific type of pharmaceutical, dosage, frequency and duration of administration, reporting of potential side effects and adverse consequences, and special instructions related to administration, are recorded by the program 110 in the patients' medical record (step 307).

In one embodiment, in order to assist and track administration compliance, feedback by the program 110 is provided directly to the patient at the point of care while the program 110 automatically records pertinent data in the pharmaceutical database 113, 114 (step 400), which can produce automated alerts by the program 110 (step 401), and physician feedback in the event of non-compliance (as noted above) (step 410).

In one embodiment, the present invention operates by incorporating or applying biomarkers to the specific pharmaceutical being administered. If the marker is applied superficially to the pharmaceutical, it can be done by the pharmacist tasked with filling and dispersing the pharmaceutical order (step 309). This may consist of a color coded applique, which is attached to the surface of each pill or tablet. The corresponding data specific to each pill or tablet (e.g., pharmaceutical agent, dose, administration frequency and duration, pertinent side effects, indication for treatment) are recorded by the program 110 into the pharmaceutical database 113, 114 in conjunction with the selected marker so that whenever the marker is recorded into the database 113, 114, the associated pharmaceutical data is automatically retrieved, displayed, and analyzed by the program 110 (step 307).

In one embodiment, the corollary is the integration of biomarkers directly into the pharmaceutical agent at the time of manufacture (step 308), which would have the advantage of directly integrating the aforementioned data along with additional manufacturer data related to quality assurance (e.g., identity of the manufacturer, location, specific ingredients, quality assurance metrics (e.g., purity).

While both approaches would create a methodology for standardized data recording and analysis, the internal embedding of biomarkers would offer the advantage of incorporating manufacturer data, which may not be readily available or as accurate, when superficial biomarkers are utilized.

In one embodiment, the use of integrated biomarkers would provide a number of advantages to conventional practice. From the standpoint of patient education and assistance, the pharmaceutical could be registered by the program 110 into the database 113, 114 each time a patient is administering a medication (step 400). As an example, the biomarker (either in superficial or embedded forms) can be registered by the program 110 into the database 113, 114 at each time of planned administration by “scanning” the pharmaceutical and its embedded biomarker into a sensor (step 400). These sensors could use a variety of available technologies (e.g., optical or radiofrequency scanning) to record the embedded pharmaceutical data into the database 113, 114 using a scanning technology, along with the identity of the patient and date/time of administration using an identification or biometrics technology (step 400).

In one embodiment, at the same time the data is being recorded by the program 110 into the patient's pharmaceutical database 113, 114 (step 400), additional data from the patient's database 113, 114 is being cross-referenced and analyzed by the program 110 to ensure that the specific pharmaceutical agent, dosage, and time of administration are consistent with prescribed therapy (step 206). In the event that an adverse event is identified (e.g., incorrect medication, improper dosing frequency, timing with another medication which could result in an adverse event) (steps 208, 409), the program 110 will issue an automated alert to the patient, caretaker, and physician (steps 209, 410) notifying them of the concern along with recommended actions/interventions.

In one embodiment, the program 110 of the present invention simultaneously records all data relevant to pharmaceutical administration into a referenceable database 113, 114 (steps 211, 307, and 404) and provides for prospective analysis to ensure compliance and pharmaceutical safety (step 404). The sensors used for biomarker registration and analysis could be integrated into a variety of existing technologies (e.g., smart phone, smart watch, jewelry) which provides for a portable method of capturing data in any location. When combined with other technologies such as biometrics and global positioning satellite (GPS), one can effectively create a computerized method of user authentication/identification, time stamped actions, pharmaceutical registration and analysis, geographic localization at the point of use, and automated alerts and prompts.

In one embodiment, “smart pill” technologies can be used, which incorporate sensors into pharmaceutical tablets of capsules, are activated by gastric acid. By leveraging these or other related or future technologies into the present invention, the program 110 can record a variety of data related to pharmaceutical administration and incorporate a series of standardized metrics into a referenceable database 113, 114 (steps 211, 307, 404) which tracks and analyzes the steps in the comprehensive pharmaceutical administration cycle.

In one embodiment, once the sensor detects the biomarker, a visual or auditory confirmation is sent by the program 110 to the end-user, notifying them of successful registration and compliance (step 400). This confirmation can be customized to each individual pharmaceutical agent in the form of a specific visual display (e.g., color, icon, symbol) or auditory cue (e.g., sound, song). This serves to provide pharmaceutical-specific feedback to the end-user with the goal of improving compliance and memory specific to the dosing schedule of each individual pharmaceutical agent.

In one embodiment, errors in pharmaceutical registration during administration can take two primary forms. The first form is when the pharmaceutical is not properly recognized and as a result, administration is not recorded in the pharmaceutical database (i.e., administration failure). This could be the result of human or technology failure. On the human side, the user may incorrectly register the biomarker with the sensor device, while the technology failure may be the result of sensor and/or biomarker failure. In either case, the lack of proper registration will trigger an automated alert by the program 110 to both the patient/caretaker and physician, notifying them of the “missed” dose (step 410).

In one embodiment, in the event that the dose was taken as prescribed but was not properly registered, the patient or caretaker has a back-up option of manually inputting data (through text or speech) into the pharmaceutical database 113, 114, relative to the administration (step 412). This manual entry of data would be simultaneously recorded in the database 113, 114 by the program 110 (step 412), along with the computer-generated registration failure, which in turn will require clarification and review by the provider (step 410). This serves as a quality assurance tool for ensuring that data is being correctly captured and if not, identifying and remedying the source of error.

For human error, additional education and training may be required to ensure that the registration process is being performed correctly. For technology error, replacement and/or refinement of sensor/biomarker technology may be required. In either case, the inherent value of the present system is predicated on accurate, consistent, and reliable data entry and analysis.

Once the pharmaceutical registration process (step 400) has been satisfactorily completed (i.e., the pharmaceutical is recognized, verified, and recorded by the program 110 in the database 113, 114), a customized prompt is sent by the program 110 to the patient or caretaker acknowledging compliance. While the majority of times this will indeed represent successful pharmaceutical administration, there will be select cases where the patient did not successfully administer the pharmaceutical agent, either intentionally or unintentionally. An unintentional administration could be the result of a physical problem (e.g., gag, vomiting) which precludes successful administration, while an intentional failure may be the result of the patient simply not wanting to take the prescribed medication (often due to unwanted side effects).

While unintentional administration failures will often be communicated with the provider (due to the fact that the patient still desires to receive the medication), unintentional failures will often not be communicated and as a result may be erroneously recorded by the program 110 in the database 113, 114 as a “successful” administration.

In order for the database 113, 114 to be as accurate as possible and identify points of failure for intervention, an additional step may be required to differentiate between “recorded” versus “completed” pharmaceutical administration. To date, the primary method of quantifying “completed” pharmaceutical administration is the use of blood assays to measure the presence and levels of a given pharmaceutical in the patient's bloodstream. This is problematic for it is an expensive, time consuming, and invasive process. It is therefore impractical to routinely order drug assays, particularly in light of the fact that many patients routinely take multiple medications.

In contrast, in one embodiment, the present invention is used to create a methodology which can routinely monitor and quantify “completed” pharmaceutical administrations through indirect and noninvasive means. One way to accomplish this is to utilize the same technology used in the registration process (e.g., optical scanners, radiofrequency scanners). In addition to utilizing these technologies for scanning embedded biomarkers in pre-administration verification, these same technologies and biomarkers can be scanned post-administration. Since the two primary means of excretion from the body are through urine (i.e., renal excretion) and feces (i.e., gastrointestinal excretion), it would be possible to scan these biologic wastes, assuming the biomarkers are not absorbed with the pharmaceutical and are actively excreted.

In this embodiment, the urine or feces would be collected and analyzed for the presence of the biomarkers in question. Since each individual biomarker would be unique for each individual pharmaceutical agent, one could scan these waste products to both detect and quantify the concentration of biomarkers, and in turn the program 110 would be able to correlate the recorded administration pharmaceutical data with that of the ingested/excreted data (step 413).

In one embodiment, the frequency with which these “ingested” administration data would be required would be dependent upon a number of factors including, but not limited to, the concern for patient non-compliance, specific type of pharmaceutical agent, disease requiring treatment, and provider requirements. As is consistent throughout the process, all data would be recorded into the database 113, 114 by the program 110 (steps 211, 307, and 404), in a standardized fashion for prospective analysis, feedback, and intervention. When data inactive of non-compliance is identified, automated alerts (step 410) would be sent to the providers of record according to the pathway described above with respect to Provider-Patient Communication.

Biomarker Verification and Pharmaceutical Inventory

A. Biomarkers

In one embodiment, the present invention offers the potential to utilize existing or new “smart” technologies which can be directly integrated into pharmaceuticals for continuous and prospective tracking and analysis of the multi-step process (i.e., continuum) of pharmaceutical therapy (step 308 of FIG. 3). One example of “smart technology” integration can take the form of embedding a biomarker directly into the pharmaceutical agent at the time of pharmaceutical manufacture (step 308), which can serve as a unique identifier of the individual pharmaceutical agent, which can be differentiated from other pharmaceuticals based on a number of standardized data elements. In one embodiment, in addition to unique identification of the individual pharmaceutical agent, these biomarkers can also link to standardized pharmaceutical registration data (see step 205, FIG. 2).

As an example, drug X may come in multiple forms and doses. The short acting versions (prescribed at 8 hour intervals) come in 50, 100, and 150 mg doses. The long acting version (prescribed once per day) comes in 200 and 300 mg doses. In order to accurately register and identify a pharmaceutical, it is important that the correct identity, dose, and version of each pharmaceutical be recorded and validated by the program 110 (steps 205 and 208). In this example, there are 5 different versions of drug X, which can be differentiated from one another through unique biomarkers. One biomarker would be specific to the 100 mg 8 hour dose, while another biomarker would be specific to the 200 mg daily dose. In addition, each specific biomarker would have associated data related to the standardized registration data described in step 205 of FIG. 2 (e.g., manufacturer, number of allowable refills, expiration date). This composite pharmaceutical-specific data would be accessible to an authorized end-user each time the pharmaceutical agent is registered (step 211) into the pharmaceutical database 113, 114.

B. Dosing

For the most part, pharmaceutical dosing regimens tend to be relatively uniform and predictable based upon the disease being treated, patient age, and patient size. In reality however, metabolic rates for individual pharmaceuticals often vary from one patient to another based upon genetic variation and organ function. Current pharmaceutical practice does not typically take inter or intra-patient metabolic differences into account, other than when significant organ system dysfunction exists (e.g., renal or hepatic failure).

If a clinical care provider had the ability to better understand inter-patient differences in pharmaceutical metabolism, which is specific to each individual pharmaceutical then in theory one could improve dosing and clinical outcomes. In one embodiment, one method for accomplishing this would be to extend the functionality of biomarkers so that they not only serve as unique pharmaceutical identifiers and data repositories, but also assist in the process of in vivo metabolic analysis. To accomplish this, in one embodiment, nanotechnology biomarkers could be directly integrated into the formulation of the individual pharmaceutical tablet or pill. As the pharmaceutical undergoes absorption, metabolism, and excretion within the body, the sequential change in quantity of these “nano-biomarkers” over time can be derived using visualization devices (e.g., external sensors, advanced medical imaging techniques like MRI or nuclear scintigraphy). Since each individual pharmaceutical would have its own unique biomarker, then one could in theory track each individual pharmaceutical when numerous pharmaceuticals are being taken. The net result would be the creation of an objective method for quantifying metabolism of individual pharmaceuticals within each individual patient.

In one embodiment, one could correlate these pharmaceutical-specific metabolic rates with the pharmaceutical regimen and clinical records to identify interaction effects which may affect an individual pharmaceutical's metabolism. As an example, suppose a patient is taking pharmaceutical A with a calculated half-life of 4 hours. When a second and unrelated pharmaceutical B is added to the patient's regimen, a change in the half-life of pharmaceutical A may be observed, from the original 4 hours to 5 hours. This interaction effect needs to be considered and factored into the dosing regimen as long as pharmaceutical A and B are prescribed concurrently.

Another example may include changes in clinical status affecting drug metabolism. Suppose the baseline half-life of pharmaceutical A is 4 hours, but changes to 6 hours when the patient experiences a change in hepatic function (as evidenced by transient elevation in liver enzymes), which may be the result of viral or drug induced hepatitis. As the severity of the hepatitis changes over time, there is a concomitant change in the observed half-life of pharmaceutical A. By correlating the liver enzyme tests and calculated half-life, one can effectively determine the interaction effect between drug metabolism and hepatic function and effectively adjust the dosing regimen in accordance with changes in liver function.

Genetics may also play an important role in pharmaceutical metabolism. In one embodiment, using large cohorts of patient pharmaceutical and genetic data, one could in theory have the program 110 create genetic maps which track the relationships between different genetic markers, patient profiles, and pharmaceutical metabolic rates. This knowledge could in turn be prospectively used by providers when a patient is being considered for pharmaceutical therapy. By the program 110 correlating the patient's genetic, clinical, and pharmaceutical profile data with that of comparable patients in the pharmaceutical database 1113, 114, customized treatment regimens can be created, which is the cornerstone of personalized medicine. The program 110 of the present invention leverages the combination of biomarkers and nanotechnology to create a quantitative system for uniquely identifying and tracking individual pharmaceuticals as they undergo metabolism, and using this derived data for customized pharmaceutical selection and dosing.

C. Pharmaceutical Registration at Administration

In one embodiment, in addition to pharmaceutical registration at the time of dispersal (i.e., by the pharmacist) (step 307), pharmaceutical registration can also be recorded by the program 110 at the time of administration (i.e., by the patient or caretaker) (step 400). This provides an important (and currently missing) step of pharmaceutical identification and authentication at the point of care. Following receipt of an automated prompt by the program 110 alerting the patient of a required dose (step 401), the patient would be expected to retrieve the pharmaceutical agent of interest from its storage device and then self-administer. (Note: a number of “smart” pharmaceutical storage devices currently exist, which provide various methods of categorizing, storing, and dispersing pharmaceuticals at prescribed regimen.)

In one embodiment, before administering the pharmaceutical, the patient or caretaker would be required to register the pharmaceutical into the database 113, 114 in step 400, which serves the important function of verifying the identity of the pharmaceutical to be taken and recording the date and time of administration.

In one embodiment, the patient (or caretaker) pharmaceutical registration process (step 400) would include placing the pharmaceutical agent into the designated electronic recognition device (i.e., a standalone device or application integrated into a multi-purpose device such as a smartphone, smart watch, etc.). In one embodiment, the recognition device would contain an electronic sensor which would be designed to recognize the biomarker embedded in the pharmaceutical, extract the corresponding pharmaceutical data, and the program 110 would receive the data and cross-reference it with the patient pharmaceutical database 113, 114 (step 414). This serves the purposes of identifying the pharmaceutical in question and making sure it accurately corresponds to the identity and dosing schedule within the pharmaceutical database 113, 114. This also ensures that the patient is taking only those medications currently prescribed, in the correct doses, and at the correct dosing schedule.

In one embodiment, in the event that the pharmaceutical detected is incorrect and not validated through this cross-referencing process, a predefined sensory alert will be provided to the patient (e.g., siren, flashing light) by the program 110, alerting them to the error (step 405). At the same time, an electronic message will be sent by the program 110 to the physician and pharmacist of record for clinical follow up and patient consultation (step 406).

In one embodiment, all data is recorded by the program 110 in the database 113, 114 for internal quality control, analysis, and future intervention (step 404). The manner in which correct and faulty pharmaceutical administration is recognized, analyzed, and acted upon by the program 110 is a unique feature of the invention. In addition to the program 110 cross-referencing the specific pharmaceutical with the patient-specific pharmaceutical database 113, 114, the identification and authentication of the individual patient or caretaker handling the pharmaceutical could also be recorded in this step through integration of identification data (e.g., biometrics, speech analysis, unique data identifier) (step 202) into the same recognition device which is recording the pharmaceutical biosensor data (step 414) (see FIG. 4).

In one embodiment, with respect to validating pharmaceutical administration at the point of care, there are two safeguards to gauge patient compliance with regards to this step. First, if the pharmaceutical is not scanned and recorded at the time of administration (step 400), then the program 110 will register this event as a “missed dose”, which in turn will launch a mandatory follow up action (i.e., text message, facsimile, email etc., with alert) to the healthcare provider (step 407).

Secondly, the pharmaceutical storage device used by the patient or caretaker can be automatically calibrated to record and track the number of individual doses (i.e., tablets, capsules, liquid ounces, pills) (step 414) at any point in time. As an example, if the prescription order called for 30 pills, then this number would be entered into the pharmaceutical database 113, 114 at the time of dispersal (step 307) by the pharmacist (along with a photographic record). When these 30 pills are in turn placed into the storage device by the end-user, comparable data would be recorded by the storage device in the database 113, 114 to ensure that the pharmaceutical dispersal and storage data matched one another (step 414).

In one embodiment, both pharmaceutical dispersal and storage can be performed and documented by the pharmacist which ensures that numerical and photographic matched data is recorded in the database 113, 114 (steps 205, 302). Other times the dispersal (step 307) would be performed by the pharmacist and storage performed by the patient (or caretaker) (steps 400, 414). In this situation, the patient would be required to document successful storage of the pharmaceutical (i.e., matching the dispersal data).

In one embodiment, each time a schedule alert (step 401) is provided by the program 110 for that specific pharmaceutical, the patient would be expected to retrieve a single dose from the storage device for self-administration. In one embodiment, a pharmaceutical specific “pre- and post-administration” inventory (steps 400, 404) would be recorded by the program 110 in the database 113, 114 to ensure compliance with the prescribed pharmaceutical regimen. The inventory can be performed through either physical, photographic, or sensor scanning methods (step 414). In the physical method, the number of doses (e.g., pills, tablets, ounces) are calculated based upon physical attributes (e.g., size, weight, shape). In the photographic method (i.e., using a camera embedded in the storage device), sequential photographic images are analyzed by the program 110 to quantify dose over time.

An alternative (and perhaps simpler) method of quantifying inventory is for the program 110 to analyze the number of individual biomarkers within the collective pharmaceutical volume. If the pharmaceutical storage device was to have an embedded sensor for detection of the individual biomarkers (i.e., which are embedded within each individual pharmaceutical), then it would be relatively easy for the program 110 to record date and time stamped inventories over time based upon biomarker detection. This ability to integrate “smart technology” within the storage device and correlate this longitudinal with the pharmaceutical database 113, 114 (step 414) represents another unique feature of the invention.

In one embodiment, if the program 110 determines that the prescribed dosing schedule does not correlate with the number of remaining doses in the storage device (i.e., pharmaceutical inventory), an alert (step 405) will be sent by the program 110 to notify the provider of the discrepancy. This discrepancy could be due to failure to take the medications as prescribed or failure to use the detection sensor at the time of pharmaceutical administration.

In one example, a patient is highly compliant in taking his/her prescribed medications at the properly designated times, but this data is not being recorded in the database 113, 114 by the program 110 due to failure by the end-user to register the pharmaceutical at the time of administration. In this scenario, the automatically recorded date- and time-stamped inventories by the program 110 would indirectly reflect the fact that pharmaceutical administration was correctly taking place at the prescribed dosing intervals but not being accurately recorded by the patient (i.e., pharmaceutical administration compliance, registration non-compliance). In this circumstance, the data would provide insight as to the requirement for additional patient education and feedback.

In one embodiment, one option would be to provide an alternative patient self-reporting option, in which the patient would be given the option for alternative data input at the time of administration (e.g., voice command “medication taken”, manual activation of an “administration completed” icon on electronic notification device, etc.) (step 415). While patient self-reporting data is often erroneous, in this case the presence of corroborating objective data from the pharmaceutical inventory would provide important complementary data for verification. In the present invention, multiple data options are available to ensure that accurate, complete, and reproducible data is collected by the program 110 in standardized formats for the purposes of longitudinal analysis and intervention which can be customized to specific patient needs (step 404).

In one embodiment, the calibrated pharmaceutical storage devices can also be used to determine when remaining doses are running out and refills are required (step 416). In that event, an automated prompt (step 417) can be simultaneously sent to the patient, healthcare provider, pharmacist, and insurer. Based upon this information, the provider can respond in a variety of ways including (but not limited to) consulting with the patient, ordering a prescription refill, allowing the prescription to end, or modifying the prescription order. By utilizing the data in the pharmaceutical database 113, 114, the physician can more accurately gauge patient compliance and the need for intervention and/or education. By incorporating the ability to prospectively intervene before the prescribed dose runs out, one can theoretically improve clinical outcomes by reducing a potential lapse in care.

In one embodiment, an additional feature of the present invention is having the ability to determine when expired or unused medications remain in the storage device inventory (which is currently a significant problem in clinical practice) (step 414). The common feature of these various applications is the standardized pharmaceutical database 113, 114, which provides an automated method of measuring pharmaceutical compliance and providing automated data to providers and payers with the goal of expediting pharmaceutical continuum of care.

D. Synchronized Inventory Management

In one embodiment, in addition to the primary pharmaceutical storage device, many patients will frequently utilize alternative (i.e., secondary) pharmaceutical storage devices for routine administration. These secondary storage devices are often portable in nature and require manual transfer of pharmaceuticals for daily administration between the primary to secondary storage devices. A patient or caretaker may elect to allocate a daily or weekly allotment of pharmaceuticals and place them into a secondary storage device in order to simplify administration, which is particularly important for patients who are out of the house (and geographically separate from the primary storage device) at the designated times of medication administration. For patients who are traveling, the ability to utilize a secondary storage device is important, and this can often become the de facto primary storage on long trips. The net result is that monitoring and tracking pharmaceutical inventory and distribution becomes problematic in conventional practice due to the inability to comprehensively record pharmaceutical data for mobile patients and caretakers. At the same time, in order to ensure accurate and reliable data analysis, it is important that the data intrinsic to each storage device is synchronized with one another as well as the central patient-specific pharmaceutical database 113, 114.

Conventionally, even if one was to utilize a secondary storage device with data collection capabilities, the existing inability to synchronize pharmaceutical data from multiple storage devices dramatically limits analysis, since the data collected is often incomplete and discontinuous over time.

In one embodiment, the present invention creates a date/time stamped mechanism which allows for around-the-clock data tracking and storage capabilities which can be synchronized between multiple individual data sources and have predefined rules directly integrated into all data collection devices for data collection, storage, analysis, and intervention.

In one example, if a scheduled dosage is missed during the course of travel, the secondary storage device will record the “missed event”. The resulting data will be transmitted and documented by the program 110 within the central database 113, 114 (step 414). If this data results in the requirement for a predefined action (e.g., automated alert (step 410) sent to ordering physician), the data-driven action will be automatically elicited. If the physician in turn elects to intervene (e.g., initiate communication with the patient), the resulting (and all subsequent) actions will be simultaneously recorded in all storage devices, regardless of physical location (steps 411 and 404).

Thus, by integrating electronic communication capabilities into storage devices and supporting technologies (e.g., smart phone, smart watch etc.), the present invention facilitates real-time intervention and communication between the central database 113, 114 (and its derived data analyses), patient, and authorized providers.

In the example described, a patient may be traveling at the time of the missed event and receive an electronic communication from the physician (step 411), inquiring as to whether the patient is aware of the missed dose and is OK. The patient may in turn notify the physician (i.e., primary care physician (PCP)) that they were in transit at the time of the scheduled dose and unable to take the medication at the scheduled time. The patient assured the PCP that they would do so within the next 30 minutes, and thanked the PCP for the follow up. The PCP requested a mandatory follow up action in 30 minutes, at which time both the patient and PCP would be notified by the program 110 (step 407) if the prescribed dosage had not been successfully taken. The patient did indeed take the medication 20 minutes after the interaction, at which time the PCP was notified of successful task completion.

In one embodiment, all data elements and corresponding communication were time stamped and recorded in the patient's database 113, 114 by the program 110 for documentation and analysis (step 404). In the event that the 30-minute time frame passed without task completion, an automated alert would be sent to the patient and PCP (step 410) with the ability to initiate a higher priority escalation pathway if needed.

The ability to synchronize data collection, analysis, and communication between multiple devices is one unique feature of the invention. In all cases it is important that the devices used in the collective processes of data retrieval, documented, tracking, analysis, and intervention undergo end-user authorization and identification to ensure the data is being accessed and viewed by an authorized individual. The method for this authorization/identification process has been previously described and creates a mechanism in which each individual end-user's identity is recorded in the database 113, 114 at the time of each data interaction.

In one embodiment, the ability of the present invention to integrate electronic data collection, analysis, and communication capabilities into all storage devices (both primary and secondary) can be accomplished in several ways. The simplest method is to directly integrate this functionality into the patient storage device itself. Alternatively, the storage device can be synchronized with an external device which can be directly worn by the patient or caretaker (e.g., watch, wrist band, bracelet, necklace etc.), or transported independently (e.g., smart phone, beeper etc.).

In one embodiment, a wearable device for monitoring data collection availability includes: 1) synchronization of multiple data repositories; 2) time-stamped data collection and analysis with reporting of “dead time” (i.e., dates/times in which data collection devices are not active); 3) synchronized inventory management between multiple data storage devices; 4) continuous real-time analysis for multiple end-users, storage devices, and medications; 5) targeted reporting of inventory management to predefined end-users (e.g., individual medication reports and analytics sent to ordering physicians/pharmacists); 6) automated alerts, prompts, and analytics regarding medication usage, leftovers, and expiration; 7) automated methods for disposal of leftover/expired meds with data tracking (e.g., pharmaceutical “take back” (i.e., standardized system of verification and drug tracking).

In one embodiment, in order to ensure that these network devices are actively receiving and transmitting data in real-time (so as to prevent the possibility of data being overlooked), these devices can contain electronic tracking capabilities which ensure they are in physical proximity to the end-user and are actively engaged. This provides the capability of creating a 3D readout at any point in time, with GPS, to identify the physical location of all devices and end-users (e.g., storage device, smart phone, patient etc.), to ensure that data can be readily received and acted upon. In the event that a designated component of the process is either physically removed or not engaged (i.e., turned off), this data will be recorded in the database 113, 114 and communication will take place with the program 110 notifying the end-user of data discontinuity. This provides the end-user with a method of retrieving data devices in the event they are misplaced, forgotten, or lost. In addition, if the data discontinuity is a recurring issue, patients and providers can elect to reconfigure the network so as to improve compliance and continuous data collection.

In one embodiment, the ability to prospectively record and analyze “dead time” (i.e., periods of time in which data is not being actively collected), is an important and unique feature of the invention for it serves to continuously track end-user compliance, technology performance and availability, and potential for fraudulent activity related to pharmaceutical dispersal and administration. If for example, a secondary storage device is lost or stolen, a number of ensuing actions and data elements will be recorded by the program 110 in the database 113, 114 for resulting action.

Firstly, the physical location of the storage device (and relative proximity to the designated end-user) will be documented and continuously tracked by the program 110, which provides important information related to physical location.

Secondly, whenever any individual attempts to access the storage device, the authorization/identification protocol will be put into effect by the program 110, which ensures that unauthorized individuals cannot access data and medications, and that the event is documented by the program 110 in the database 113, 114 as a potentially unauthorized data intrusion.

In one embodiment, in the event that repeated unauthorized attempts are made to open the storage device, an anti-theft trigger can be automatically initiated by the program 110, which causes the storage device to be permanently locked or destroyed (e.g., built in electrical sensor initiated an electrical pulse or microwave for medication destruction).

Thirdly, the disassociation of the network (e.g., storage device, patient, smart watch etc.) will cause the program 110 trigger a “dead time” warning, which identifies that a period of time has occurred in which synchronized data is not being collected and analyzed (i.e., due to the removal of the storage device from the network). Dead time is an important indicator of data activity and accessibility and when identified needs to be acted upon and investigated to ensure proper functioning of the network and data accuracy/integrity.

An alternative (and less insidious) example of dead time is when one of the synchronized devices is inactive, such as the physical separation of the patient's smart phone from the secondary storage device. In this example, the patient has a wearable storage device (e.g., necklace), which allows for her to store a 12-hour supply of medications and administer them as needed. The patient has elected to use her smart phone as a means of communication and data display, but in this case has left it in another purse, which effectively creates an incomplete data network. The ability for the program 110 to record and track data from multiple sources creates an alert as to the data discontinuity, but effective intervention is lacking due to the inability to alert the patient through the only available device, the storage necklace. If this problem was to recur over time, it may be determined by the patient, caretaker, and/or providers that an alternative technology solution may be required. Since the patient's smart phone appears to be the limiting factor, she is presented with the option to switch to an alternative storage device with integrated data display and communication capabilities (e.g., smart watch with storage capabilities). This example illustrates how “dead time” data can be analyzed by the program 110 and used to optimize technology selection and integration, as well as serve as technique for fraud detection and prevention.

In one embodiment, the same functionality of primary storage devices can also be incorporated into secondary storage devices including (but not limited to) pharmaceutical registration, end-user registration, pharmaceutical administration, automated data alerts and prompts, and inventory management. For inventory management, simultaneous real-time data can be combined from both primary and secondary storage devices by the program 110 to provide comprehensive data regarding comprehensive inventory, specific to each individual pharmaceutical agent.

In one embodiment, this takes on greater importance when analyzing the need and timing of prescription refills and/or left over medication. It would not be unexpected for a given medication to be distributed across multiple storage devices, which can often be forgotten (especially in the setting of elderly patients with memory impairment). Suppose for example, a patient distributes a certain medication across three (3) different storage devices (e.g., primary, secondary for daily use, and secondary for long term travel). Before embarking on a two (2) week trip, the patient (or their caretaker) allocates a 2 week supply of a given medication within the travel storage device, along with a 2 day supply within the secondary daily use device (since the travel storage device is packed away and temporarily inaccessible). After returning from the 2 week trip, there remains a one day dosing regimen in the daily storage device unit along with 2 days dosing within the travel storage device unit, because the trip was cut short. During the course of unpacking, the patient does not empty the travel storage device of “leftover” medications. She does however, return the daily use dose to the primary storage device, where it is accounted for and inventoried. In the course of daily activities, the patient continues to take the medications as prescribed, alternating between the primary and secondary daily storage devices. The leftover medications within the travel stage device would be largely forgotten, if not for the integrated tracking capabilities, continuous inventory management, and synchronized data analysis of the network and individual components by the program 110. As long as the travel storage device remains “on line”, each daily inventory management analysis will record the remaining inventory for each individual storage device and provide a sum total, which is correlated with the individual medication profile (e.g., date of dispersal, number prescribed, dosing regimen, expected date of completion, number of ordered refills, expiration date, etc.). If the travel storage device was to go “off line” (i.e., disconnected from the pharmaceutical storage network), an automated alert would be sent by the program 110 along with location tracking, providing one with the ability to locate the device and reintegrate it into the network to ensure accurate and complete data collection and analysis.

In one embodiment, as the number of remaining medication doses reaches a predefined level (e.g., 2 day supply remaining), an automated alert will be sent by the program 110 to authorized end-users (e.g., patient, ordering physician, pharmacist etc.) to notify them of impending completion and the requirement for prescription refill in the event that the medication is to be continued. This analysis of impending inventory depletion is performed both on individual and collective storage device levels, which provides the ability to track all remaining doses.

In one embodiment, the remaining doses will all be located in the primary storage device. However, in the example above, the remaining 2 day dose in the primary storage device is supplemented by the additional 2 day dose in the travel storage device, which effectively creates a four (4) day total dose inventory. Since the patient has effectively forgotten about the remaining supply in the travel storage device, this would be expected to be “lost”, but the ability of the program 110 to continuously track, record, and analyze, provides an effective tool for accounting for the complete medication supply (i.e., medication dispensed, medication administered, mediation remaining among all storage devices).

In one embodiment, the following data will be automatically reported by the program 110 to authorized end-users at the predefined time of 2 days prior to inventory completion within the primary storage device:

a. Pharmaceutical identification (Medication name, manufacturer, dose etc.).

b. Prescription data (Number dispensed, dosing regimen, date of dispersal, expected date of completion, refill number if applicable, ordering physician, pharmacist of record, etc.).

c. Inventory management (remaining doses, expected date of completion, administered doses accounted for, etc.).

d. Primary storage device.

e. Secondary storage device (daily use).

f. Tertiary storage device (travel).

In one embodiment, based upon the data recorded and analysis, the program 110 will identify that the remaining inventory in the primary storage device equates to 2 more days of the ordered dose. Normally this would trigger an automated request by the program 110 for prescription refill to the pharmacist and ordering physician, if applicable. However, in this example, the additional 2 day supply in the travel storage device would prompt an automated alert by the program 110 to the patient, notifying them of the additional dose which needs to be utilized before a refill order can be processed. The patient would then be expected to retrieve the 2 day dose from the travel storage device, add it to the primary storage device, and then continue to take the medication as prescribed until the complete remaining drug supply is depleted to the predefined 2 day time period, in which an automated refill order is placed by the program 110.

In one embodiment, the above method of the present invention provides a comprehensive pharmaceutical inventory tracking and accountability, regardless of the number of individual storage devices being utilized. As is the case with pharmaceuticals and end-users, all storage devices must first go through a formal registration process in order to be induced in the network and database tracking/analysis of the program 110 of the present invention.

The issue of accountable pharmaceutical disposal has recently taken on heightened importance and has become a driver for recent legislation for mandatory “take back” programs, which have been instituted in several municipalities to date. The primary purpose of these legislative initiatives is to ensure that “leftover” medications are accounted for and disposed of in a controlled fashion, so as not to encourage illicit drug usage and chemical contamination of water supplies. Since current practice is largely dependent upon voluntary disposal by patients and purchases from drug companies; there remains a great deal of gaps in ensuring that all leftover medications have been accounted for and have been adequately disposed of. By creating a pharmaceutical database and a program 110 which tracks all pharmaceuticals, registrations, communications, and end user actions through the individual steps of ordering, dispersal, administration, and inventory management, the program 110 of the present invention creates an ideal method for managing drug disposal in an accountable fashion. The inventory management component of the present invention will record real-time standardized data for each individual pharmaceutical in storage, and correlate this with the ordering and administration data, to determine when a given pharmaceutical is determined to be “left over”, which is defined as past the due date for therapy completion. This data can also be correlated by the program 110 with manufacturer data to determine when “leftover” medications have exceeded their recommended expiration dates and are no longer deemed safe for usage.

In one embodiment, automated pathways and rules can be created by the program 110 for each individual pharmaceutical in accordance with its therapeutic usage, safety profile, and potential for illicit usage. Based upon these combined factors, rules can be established by the program 110 to determine the criticality and timeliness of leftover drug disposal. Pharmaceuticals which are determined to be “high priority” for drug disposal (e.g., controlled substances, specialized antibiotics used for antibiotic resistant bacteria, drugs associated with high organ toxicity etc.), would in turn have rigid criteria for drug disposal which require immediate disposal. In the event that these “high priority” pharmaceuticals are not documented to be disposed of in a narrow and predefined time frame, the program 110 will institute an automated escalation pathway to ensure that disposal has been satisfactorily completed in accordance with mandated requirements, and associated time stamped and end-user identification data is recorded in the database 113, 114 for monitoring and analysis.

In one embodiment, an example of an escalation pathway for a high priority pharmaceutical may include the following actions, time restrictions, and data elements for documentation.

a. Patient notified of leftover status by the program 110, and requirement for documented disposal on day of prescription completion and of a recorded inventory excess.

b. Failure to act within 48 hours prompts an automated alert by the program 110 to the ordering physician, who is required to acknowledge receipt of the alert, requirements for disposal, and data documentation.

c. If disposal is not formally documented by 72 hours, an automated alert is transmitted by the program 110 to the local health department for follow-up actions.

d. In the event that the pharmaceutical in question is categorized as a public safety hazard (e.g., controlled substance), local law enforcement is notified by the program 110 by day 5 if disposal has not been documented.

e. Failure to ensure disposal by day 7 may result in fines or other disciplinary action.

In order to sufficiently document that drug disposal has been satisfactorily completed, a number of methods can be employed. Manual disposal may include a number of options including (but not limited to) transfer of the pharmaceutical to a licensed pharmacist, return of the leftover medication to an authorized physician, or return of the pharmaceutical to a drug manufacturer representative. In all cases, the following data is recorded by the program 110 in the pharmaceutical database for formal documentation and future review.

a. Identities of the parties involved.

b. Date and time of transfer.

c. Pharmaceutical agent, dosage, and number.

d. Method of disposal.

In one embodiment, automated methods of disposal can also be utilized which can be integrated by the program 110 directly into the pharmaceutical storage device and inventory management system. As an example, the storage compartment assigned to a specific pharmaceutical which has been determined to have leftover medications, would create a formal record of the leftover pharmaceutical agent and number (e.g., photographic records and pills along with sensor data).

In one embodiment, the pharmaceuticals can in turn be rendered biologically inactive through chemical additives (e.g., coffee grounds) or physically destroyed (e.g., crushed, thermal ablation). These actions can take place in a designated compartment within the storage device which has been specially equipped for pharmaceutical disposal, thereby allowing for the actions to take place in a controlled environment which has the same capabilities for inventory management and pharmaceutical/end-user registration. The end goal is to create a self-enclosed system which provides for leftover medication to be disposed of locally, while ensuring that the disposal process and associated data has been documented and recorded in the pharmaceutical database 113, 114 by the program 110.

Data Analysis and Customized Self-Reporting

In one embodiment, the present invention has the important features of recording, tracking, and analyzing real-time prospective data, which provides an opportunity to intervene at the point of care, which maximizes clinical impact and patient outcomes. In addition to the aforementioned standardized data captured by the program 110 with pharmaceutical administration (which is intrinsically tied to each individual and specific pharmaceutical agent), another feature of the invention is the recording of patient self-reported data. This self-reported data offers the ability to capture data related to pharmaceutical administration as well as dynamic data specific to the patient. In one embodiment, the self-reporting data metrics include the following.

a. Compliance to prescribed treatment regimen.

b. Emotional state, stressors, and overall well-being.

c. Provider and caretaker communication.

d. Documentation of data requirements (e.g., medication side effects, glucose measures etc.).

e. Utilization of education resources.

f. Physical and cognitive limitations.

g. Provider assessment and satisfaction.

h. Social factors (e.g., alcohol, illicit drugs, smoking, social interactions etc.).

i. Overall attitude towards treatment plan.

The above dynamic patient specific data provides important information related to the emotional, physical, and cognitive states of the patient at the time of each prescribed medication dosage. The important feature of this data is that it may change over time, and as a result must be continuously monitored by the program 110 for evidence of clinical change in the patient which may affect compliance and adherence to prescribed medical therapy.

As an example, suppose a patient experiences periodic emotional lability, with periodic episodes of self-reported depression, which are often associated with missed or erroneous pharmaceutical administration. Through the program's analysis of the patient's historical data profile, a clear pattern of continuous non-adherence during self-reported depressive episodes is shown, the episodes which typically last between 3-7 days, depending upon the circumstances and intervention. When the patient prospectively seeks assistance (e.g., communication with healthcare provider or family member), the depressive episodes tend to be shorter in duration (e.g., 3-4 days), as opposed to depressive episodes without intervention. On a few occasions, the patient has responded to depressive episodes through self-medication (of available pharmaceuticals), ethanol, or illicit drug use. These self-directed negative interventions tend to occur when the depression is of greater severity and/or attempts to communicate with family or providers are unsuccessful. The resulting analysis by the program 110 reveals the following insights: a) pharmaceutical nonadherence is frequently triggered by episodes of depression; b) the higher the severity of self-reported depression, the greater the severity of nonadherence and the higher likelihood of ethanol or drug use; c) when the patient engages in communication with a family member and/or healthcare provider, the duration of nonadherence is decreased; and d) episodic depressive states can in part be predicted by social interactions, dietary change, and external stressors.

In one embodiment, using this historical patient-specific analysis by the program 110, the program 110 can create a proactive interventional strategy using prospective patient self-reported data. When any of the predetermined risk factors (i.e., triggers) are identified, an automated alert can be sent by the program 110 to designated healthcare providers or family members for further evaluation and potential intervention. At all times, whenever data is accessed, analyzed, communicated, or acted upon, it will automatically be recorded by the program 110 in the patient pharmaceutical database 113, 114, with the identity of involved parties along with time stamped records of the corresponding data. This becomes important in longitudinal analyses, in identifying causative factors associated with noncompliance along with determining the relative success of interventions and involved individuals.

In additional to changes in the patient's emotional state, self-reported physical and cognitive changes may also play a role in pharmaceutical compliance. Examples of such physical changes may include transient physical changes related to pharmaceutical administration (e.g., vomiting, sore throat, esophageal spasm) which prevent the patient from ingesting oral medication. When made aware of these physical limitations prospectively, a healthcare provider may intervene by changing the medication regimen (e.g., suppositories in lieu of oral tablets, reducing the dosing frequency from three times to once a day etc.) or providing new medical therapy specific to the physical limitation.

Cognitive changes are a critical factor in pharmaceutical noncompliance and may also be transient in nature. Causative factors may include (but not limited to) medication changes, acute illness, or external events (e.g., loss of a loved one) etc. In many situations, patient self-reported data may not be accurate in reflecting cognitive change and instead may require some sort of external evaluation. A wide array of cognitive tests are readily available to assist in analysis, which can be directly integrated by the program 110 into the self-reporting technology being used.

As an example, in one embodiment, memory tests may be directly inserted by the program 110 into the self-reporting application which can record and analyze the results in real time. In the event that a change above the patient's baseline was recorded by the program 110, a second test may be employed for verification. In the event that the second test corroborated the initial test result, an automated alert would be sent by the program 110 to the provider for more extensive testing and intervention. This illustrates another unique feature of the invention; objective data measures can be integrated by the program 110 along with the self-reporting data to supplement and improve the derived real-time analytics. In all cases, the historical data of each individual patient is retrieved and analyzed by the program 110 to detect change beyond baseline. This reflects another example of how individual patient profile data is used by the program 110 to assist in data analysis and identify subtle changes which may otherwise go undetected.

Whenever self-reported data is used for prospective analysis, there is always the concern of data accuracy. Patients may enter erroneous data either intentionally (i.e., “gaming the system”) or unintentionally, but in the end, this undermines the validity of the analysis, as well as the opportunity to prospectively intervene at the opportune time. A number of techniques have been described to address intentional input of inaccurate data, which in the case of monitoring patient compliance, often represents an attempt on the part of the patient to mislead providers into believing they are complaint when in actuality they are not. If this inaccurate data is taken on face value, then data indicative of noncompliance is not accurately recorded by the program 110, thereby preventing timely intervention.

In one embodiment, program 110 strategies which can be used to circumvent intentional data misrepresentation include (but are not limited to) repeating questions in different formats, periodic changes in the data being collected by the program 110, incorporating the use of rating scales (as opposed to simple yes or no questions), and having the program 110 correlate self-reported data with externally validated data. External validation can be recorded by the program 110 in a number of ways, including (but not limited to): objective data recorded with pharmaceutical administration, data provided by healthcare providers, clinical and laboratory testing (e.g., blood pressure measurements, drug assays, alcohol blood levels, glucose monitoring), and natural language processing (NLP) analysis of text-based patient communications (e.g., social media postings, provider communication).

The combined analysis of this data by the program 110 can be used to create a patient-specific measure of self-reporting accuracy, which is another unique feature of the present invention. This measure of data accuracy provides providers with a point of reference as to the verifiability of the patient self-reported data, as well as providing context as to the degree with which patient self-reported data should be used in overall compliance analysis. Patients with relatively poor self-reporting accuracy measures would require more frequent external data audits by the program 110, and closer monitoring than those patients with high self-reporting accuracy scores in order to properly utilize self-reporting data for healthcare decision making and intervention. Third party payers may elect to use these self-reporting accuracy scores in determining a variety of economic measures such as insurance premium rates, co-pays, and deductibles. This could in theory provide a greater incentive for patients to become more accurate and reliable in their self-reporting data responsibilities.

Since the patient-provider relationship (i.e., therapeutic alliance) has been demonstrated to play a critical role in determining patient compliance, it should be reflected in self-reported data. Numerous studies have shown deterioration in patient-provider communication, confidence, and trust all have the potential to adversely affect patient noncompliance and clinical outcomes. In the event of such worsening, it is essential that the perceived problem be rapidly identified and intervened, in order to re-establish and/or improve patient confidence and compliance with the prescribed therapeutic regimen. Since providers play a critical role in determining the overall success (or failure) of the therapeutic alliance, their self-reported data input is also important in the overall analysis. In the event a disconnect is observed by the program 110 between patient and provide self-reported data, then an external review and analysis may be instituted by the program 110 to better assess the data discrepancy and need for intervention. Potential interventions may include (but not limited to) frequent patient-provider communication schedules, targeted educational programs, and reassignment of providers.

The ultimate goal of incorporating patient self-reporting data into the pharmaceutical database is to provide a unique data source which captures the perceptions and subjective assessment of each individual patient. This self-reported data can in turn be used by the program 110 in the creation of patient profiles, early indicators and risk factors for potential noncompliance, and factors which can be instrumental in predicting clinical outcomes.

Automated Feedback

As noted herein, there are numerous ways the present invention provides automated feedback to a variety of users (i.e., physician, pharmacist, patient, caretaker etc.). These features are important to ensure that there is an automated method for data collection and analysis which can serve as a vehicle for pharmaceutical meta-analysis and creation of data-driven best practice guidelines.

Intervention and Follow-up

In the event that repetitive problems occur with pharmaceutical administration, intervention may be required, which can be designed in accordance with the clinical severity of the problem, the specific pharmacologic agent in question, and the individual patient profile. Regardless of the specific type of intervention employed, the critical determinant to measuring success is patient compliance. If one can effectively create an accurate and reproducible method of measuring patient compliance (on both individual pharmaceutical and collective levels), then determining the comparative efficacy of different interventions strategies becomes feasible. A methodology for quantifying patient compliance is discussed later in detail and is an integral component of the invention.

In one embodiment, the present invention allows for intervention strategies, which can include customizable educational programs based upon the individual patient profile and specific pharmaceutical deficiency. Educational content, presentation state, and mode of delivery can all be customized and subjected to longitudinal analysis by the program 110 to determine the optimal educational strategy for each individual patient, clinical status, and pharmacologic agent. As more educational data is created and analyzed by the program 110, the derived educational database 113, 114 can be used prospectively to identify the specific content best suited for the individual patient based upon their individual patient profile (which will be discussed in greater detail later), historical usage and feedback, and outcomes analysis. By continuous data tracking and analysis by the program 110, the cause and effect relationship between the pharmacologic error and the education intervention can be established, thereby determining whether (and to what degree) the educational program was successful in improving patient compliance, and whether additional intervention is required.

In one embodiment, another level of intervention is the institution of healthcare consultations, which are aimed at establishing a direct communication pathway between the healthcare provider (e.g., nurse, physician, pharmacist) and patient. These consultations can take the forms of electronic, telephone, or in person communication. The date/time, identities of the individuals, and content being discussed are recorded in the pharmacologic database 113, 114 by the program 110, and tagged to the specific problem which prompted the consultation. Once again, longitudinal analysis of the pharmacologic error is tracked by the program 110 to determine the impact of the consultation on patient compliance. Both the patient and healthcare provider are automatically provided with outcomes data to provide relevant feedback. Those patients and/or providers who are shown to have positive outcomes resulting from consultations are identified by the program 110, and their profiles are updated by the program 110 to record the beneficial impact of consultations on outcomes analysis. This can serve as a means to direct future interventions and incentives in accordance with previous consultation success or failure.

In one embodiment, another intervention option is through technology utilization. Technology can be created and customized to the specific needs and preferences of the individual patient or caretaker to improve compliance and adherence to the prescribed medication regimen. Examples could include automated electronic prompts, text messages, or telephone reminder calls at the prescribed time of medication administration. These can be associated with patient or caretaker receipt acknowledgment to ensure that the predefined communication pathway was sent and received at the correct time intervals. In the event that an automated alert or telephone call went unanswered or non-confirmed, an automated alert could in turn be sent by the program 110 to a designated caretaker, family member, or physician of record, to notify them of the lack of response and likelihood of pharmacologic noncompliance.

In one embodiment, another option for intervention is alteration of the medication regimen, which is a last resort when other intervention attempts have been unsuccessful. Once a patient has demonstrated a consistent pattern of noncompliance which places them at increased clinical risk, a physician may elect to prescribe an alternative with a safer profile and/or easier regimen to adhere to. The ultimate goal is to create an automated system for recording, tracking, and verifying pharmaceutical administration, with integrated education and feedback prompts to facilitate increased patient compliance. In addition to traditional modes of communication, the present invention also utilizes alternative multi-sensory communication schema designed to improve patient understanding and pharmaceutical identification, which is a particular problem when multiple different medications are being prescribed and the involved patient or caretaker has cognitive impairment.

Patient Profile and Compliance Characterization

In one embodiment, the present invention includes a Patient Pharmaceutical Profile, which serves as a way in which patients can be categorized based upon a number of variables and attributes, which can collectively be used by the program 110 to define similarities and trends in large patient populations to assist in defining best practice guidelines, clinical decision support, education strategies, technology utilization, and communication.

In one embodiment, the Patient Pharmaceutical Profile includes a number of categories related to patient demographics, socioeconomics, education, clinical status, and compliance. In one embodiment, the Data Elements with the Patient Pharmaceutical Profile include:

A. Demographics: 1) age, 2) gender, 3) ethnicity, 4) religion, 5) address, and 6) marital status.

B. Education: 1) highest level of formal education, 2) occupation, 3) healthcare literacy, 4) language literacy, 4) computer proclivity, and 5) participation in education.

C. Clinical: 1) medical and surgical history, 2) active medical problem list, 3) cognitive level, 4) visual acuity, 5) motor skills and mobility, 6) hearing, 7) pharmaceutical regimen, 8) genetics, 9) allergies, 10) side effects and adverse drug reactions, 11) organ system dysfunctions, 12) size and weight, 13) diet, and 14) speech.

D. Socioeconomic: 1) economics, 2) insurance status, 3) social history (illicit drug use, smoking, alcohol etc.), 4) environmental factors, 5) family dynamics and support system, and 6) transportation access and availability.

E. Compliance: 1) adherence to prescribed regimen, 2) reporting of adverse actions, 3) maintaining scheduled appointments, 4) utilization of healthcare technology (e.g., home health monitoring), 5) reporting of lost or stolen medications, 6) providing access to healthcare records, 7) communication with healthcare providers, 8) following medical directives and testing, 9) participation in educational initiatives, and 10) documentation and reporting of changes to healthcare status.

While all of the above categorical profile data ultimately defines each patient's collective profile, perhaps one of the most important is that of Compliance, since this is one of the things that will ultimately have a profound impact on the relative success and optimal strategy for pharmaceutical therapy.

Pharmaceutical regimens which are more complicated and/or dependent upon active patient participation for therapeutic success will in large part be dependent upon the level of patient compliance. Patients with lower compliance scores may not be deemed optimal candidates for such a pharmaceutical regimen, unless a proactive intervention can be performed to improve compliance with the prescribed therapeutic regimen. As a result, patients with lower compliance scores may require selection of an alternative pharmaceutical regimen, with a higher safety profile in the event that a dosage is delayed, missed, or taken in excess.

In one embodiment, the variables listed above in the Compliance section of the Patient Profile can also be used to create a separate Patient Compliance Scoring System, which would also be applicable to a variety of medical disciplines apart from pharmaceutical administration. A wide array of medical and surgical subspecialties rely in large part upon patient compliance in order to achieve optimal clinical outcomes. When a healthcare provider is aware of deficiencies in patient compliance, they may alter their choice of diagnostic or therapeutic options.

For diagnostic procedures such as MRI or a percutaneous biopsy, the overall success of the procedure in achieving accurate and safe diagnosis is in part dependent upon the ability of the patient to comply with medical directives. If the patient is unable to do so (which may be due to behavioral, educational, or medical issues etc.), the clinical outcome may be adversely affected with resulting poor image quality, inaccurate diagnosis, or iatrogenic complications (e.g., hemorrhage, organ injury, pneumothorax). For medical/surgical treatment planning, areas such as medical and surgical oncology are highly dependent upon patient compliance in determining the optimal course of clinical action. If for example, a patient with a high grade malignancy is being considered for an aggressive form of surgery or chemotherapy, the physician may want to consider the ability of the patient to comply with fairly strict and complex medical directives. If the patient is unable to do so, then the optimal treatment choice may be that of a more conservative approach, which is less dependent upon patient compliance.

Existing medical records may occasionally contain information related to patient compliance, but this information is largely isolated and when present, exists in a non-standardized format. In one embodiment of the present invention, in order to accurately characterize patient compliance, a quantitative reference model is created by the program 110, which can track compliance scores over time using a standardized methodology. This provides for an historical analysis of patient compliance, which can be applied specific to the medical context in which it was analyzed (e.g., pharmaceutical administration, surgical treatment, diagnostic medical imaging, diet, etc.). The ability for the program 110 to track and analyze compliance in such a context-specific manner provides for greater applicability, since compliance can vary in accordance with different clinical scenarios and providers. A patient may have a better working relationship (e.g., trust, communication, mutual respect) with one provider than another and as a result experience different compliance scores. In addition, a patient's compliance scores may change over time (e.g., based upon differences in psychosocial factors, cognitive ability, and health status), and these temporal changes should therefore, be taken into consideration. The net effect is that assessment of patient compliance by the program 110 is a dynamic process which may in part, be influenced by a number of external factors including medical context, provider, and time. The creation by the program 110 of a standardized referenceable database 113, 114, provides in depth knowledge of the various factors affecting individual patient's compliance; while also providing a mechanism in which patients of similar profiles can be analyzed by the program 110 using large sample size statistics to determine best practice guidelines in relationship to different degrees of compliance.

Presently, with respect to pharmaceutical treatment planning and administration, pre-existing knowledge of patient compliance may have a profound impact on provider decision making. If, for example, a patient is being seen by a physician for the first time (e.g., change in primary care provider, move to a new geographic location, emergency room visit), he/she would have little knowledge relating to patient compliance. Available information in the patient's medical record would list results from previous tests/procedures, medical problems, past medical/surgical history, and current pharmaceuticals. However, it is unlikely that information related to patient compliance would be documented, and if it was, it would be difficult to locate within the vast array of medical data. The physician would therefore, make a decision related to pharmaceutical therapy based upon the clinical presentation of the patient, their personal pharmacologic knowledge and experience, and established best practice guidelines. In all likelihood, the physician would instruct the patient as to their diagnosis and recommendations. If the patient is coherent and cooperative, the physician would likely assume the patient to be compliant, and provide them with a prescription along with recommendations for follow-up (e.g., future clinical appointment, consultation with specialist, additional clinical testing).

Since pre-existing compliance data is rarely available for review, the physician does not have any verifiable knowledge as to whether the patient will follow the instructions given and comply with the prescribed therapy. A number of non-compliance related clinical outcomes may result. The patient may fail or delay in filling the prescription, not take the full course of therapy, or fail to take the dosage as prescribed (e.g., missed doses, excessive doses). Any of these compliance failures could adversely affect the clinical outcome of the patient and represent a “failed” pharmacologic therapy. In actuality, the “failure in therapy” was not a result of incorrect diagnosis or treatment, but instead the result of patient non-compliance.

If, on the other hand, the physician had access to the standardized patient compliance data of the present invention, at the time of presentation, he/she may be able to factor this compliance data into their treatment planning. Something as simple as knowing if the patient has failed to fill prescription orders in the past, may result in a prospective intervention on the part of the physician, by directly contacting the pharmacy of patient choice, consulting with the pharmacist, and request for notification once the prescription order has been filled and given to the patient. Alternatively, if analysis by the program 110 of the patient's pharmaceutical compliance data, demonstrates a failure to comply with dose regimens of two or three times per day, the physician may alter his/her prescription order to an alternative drug which can be taken once daily. The key point is that each patient has their own compliance history, which if recorded and analyzed by the program 110, can produce valuable insights affecting clinical decision making and treatment planning.

The Patient Pharmaceutical Profile (above) is one unique component of the invention and provides for valuable data analytics which are not readily available in existing practice and technology. In one embodiment, an important attribute is the ability to record, track, and analyze data within the Patient Pharmaceutical Profile in a standardized fashion, using the program 110. Using the Compliance section of the Profile above, as an example, each individual data element can be quantified by the program 110 in a numerical fashion (e.g., using a Likert scale ranging from 1 to 5), with the data source recorded by the program 110 at the time of data classification.

If, for example, a patient's primary care physician is compiling the Compliance data for the first time, they would be required to provide a numerical score for each of the 10 Compliance data categories contained in that section of the Profile. In the event that a poor compliance score was recorded (i.e., 1 or 2), the physician would have the opportunity to input supporting data (e.g., frequently missed scheduled office appointments), along with the specific dates and times that these supporting data took place. This provides a timeline of patient compliance, the ability to upgrade compliance data over time, and input from multiple data sources. If another healthcare provider (e.g., pharmacist) was to input conflicting compliance data (e.g., failure to fill prescriptions in a timely fashion), the data sources could be queried by the program 110 with the goal of clarifying the recorded compliance data in a consistent fashion.

Over time and with longitudinal data analysis performed by the program 110, the inputted data from a variety of data sources can be analyzed by the program 110 for accuracy, in order to assist in weighting the inputted data commensurate with the long term accuracy of each individual data source. In the event that individual data sources are shown to provide inaccurate data on a repetitive basis, their ability to input data may be reduced or eliminated. This provides an important quality assurance function of the Patient Pharmaceutical Profile database 113, 114.

Patient Compliance and Interaction Effects

In one embodiment, an important and unique feature of the Patient Compliance Profile and scoring system of the present invention, is the ability of the program 110 to correlate an individual patient's compliance with that of the provider (both individual and institutional providers), technology, task, and clinical context. While many patients will demonstrate consistent levels of compliance throughout their healthcare continuum, other patients may demonstrate inconsistencies in compliance (i.e., intra-patient compliance variability), which may be the result of numerous factors including (but not limited to) external circumstances (e.g., recent job loss, divorce, loss of transportation), change in clinical status (e.g., onset of memory deficit, deterioration in physical status), change in finances (e.g., job loss, change in insurance coverage), changing relationship with an individual or institutional provider, changing clinical task requirements (e.g., dietary change, change in therapeutic regimen), or change in supporting technology (e.g., new computer-based home health monitoring, loss of on-line functionality). In the end, patients experience numerous and continual changes and challenges in everyday life, many of which will affect their ability to comply with medical directives and participation in healthcare expectations. In order to accurately gauge compliance and actively intervene in a positive manner, it is essential that measures of compliance and contributing factors are accounted for (in a consistent and standardized fashion), analyzed, and acted upon.

One of the most important of these “compliance influencers” is the profound impact individual providers may have on patient compliance. Since interpersonal relationships are a dynamic process and subject to human emotion, it is not unexpected that changes in patient compliance may occur (in both positive and negative directions) over time as relationships between providers and patients undergo change. Changes in patient compliance may occur when comparing individual providers (inter-provider variability) as well as within an individual provider over time (intra-provider variability). One would expect that those providers who allocate greater amounts of time to patient engagement, education, and empowerment would likely have higher levels of patient compliance than their counterparts who devote less time and effort to these pursuits. Since human emotion and personality play a fundamental role in defining the relative success (or lack thereof) in these relationships, any attempt to optimize patient compliance should take these factors into account.

In one embodiment, in order to account for these “human factors” and their effect on compliance, the program 110 of the present invention (and its quantitative analysis) incorporates a number of variables (e.g., personality, interpersonal interaction, compassion, education, and communication skills) into the provider and patient profiles in order to quantify and attempt to optimize patient compliance as it relates to patient-provider interactions. By providing healthcare providers with this comparative analysis, the goal of the present invention is to improve patient compliance and clinical outcomes, and provide each end-user with greater insight and knowledge into how their personal interactions with each individual patient can improve.

In one embodiment, to illustrate how this patient-provider interaction is subject to analysis, an example of a patient with high variability in compliance measures is used, and one can evaluate how healthcare provider interactions can influence and change patient compliance over time. In this example, the patient (Mrs. Smith) has multiple medical problems (e.g., coronary artery disease, hypertension, diabetes, peripheral vascular disease, anxiety disorder, carotid artery stenosis, and stroke) and is seen by a number of healthcare providers including subspecialists in cardiothoracic surgery, endocrinology, ophthalmology, and cardiology. The patient has recently switched her primary care physician (PCP) and the new PCP, Dr. Jones, is reviewing Mrs. Smith's records to review past medical/surgical history, ongoing problems, recent lab work and medical imaging studies, consultation notes, and pharmacology regimen. In the reviewing the pharmacology regimen, Dr. Jones notices that several changes in medication orders have taken place over the past 6 months, which have been initiated by both the previous PCP (Dr. Harrison) and subspecialist physicians. With regard to diabetes treatment, Mrs. Smith has recently had several changes in both oral diabetic medications as well as insulin, with poor control of blood glucose. Both the PCP and consulting endocrinologist have documented that Mrs. Smith often reports running out of her medications which results in several missed doses along with a recent hospitalization for hyperglycemia. While in the hospital, a consulting dietician noted that Mrs. Smith's dietary regimen is inconsistent with ADA standards and recommends that a formal 1800 calorie ADA diet be instituted. After discharge from the hospital, Mrs. Smith missed her scheduled follow-up appointment with the dietician and no further dietary consultation took place. The program-documented compliance scores have markedly worsened over the past year with deteriorating compliance scores in the following areas: a) adherence to prescribed regimen (previous compliance score 3, current score 1); b) maintaining scheduled appointments (previous score 4, current score 2); c) communication with healthcare providers (previous score 3, current score 2); d) following medical directives and testing (previous score 3, current score 1).

While several consultants have documented these poor compliance scores, the largest change has been recorded by the previous PCP Dr. Harrison. Along with the declining compliance scores, Dr. Harrison notes that Mrs. Smith has become increasing agitated and emotionally volatile and as a result has been referred to a psychiatrist, but never followed up on this referral. Dr. Harrison believes that the declining compliance is in large part due to organic brain disease and has instructed Mrs. Smith and her daughter to consider relocation to an assisted living facility. After reviewing the healthcare records, the new PCP Dr. Jones talks with Mrs. Smith and her daughter to ask about the recent changes which have occurred and inquires as to what changes Mrs. Smith thinks are necessary to improve her diabetes treatment regimen, overall health status, and compliance. Mrs. Smith admits that she has often been negligent about filling her prescriptions in a timely fashion and not showing up for scheduled appointments. She states that some of these compliance failures are due to the poor relationship she has had with her previous PCP Dr. Harrison who was always in a rush, didn't listen to her, failed to explain changes in her medications, and too often referred her to other subspecialists rather than take care of the problems himself. Dr. Jones assured Mrs. Smith and her daughter that he would try to communicate more effectively with Mrs. Smith, engage her on all medical decisions, and actively collaborate with all consultants to assure continuity of care. In turn, Mrs. Smith stated she would give her best effort to work with Dr. Jones and take greater responsibility in her healthcare. After speaking with Mrs. Smith's daughter in private, Dr. Jones learned that some of the deterioration in Mrs. Smith's physical and emotional state took place after her recent hospitalization.

Dr. Jones utilized a unique component of the Compliance and Pharmaceutical databases 113, 114, where the program 110 creates a longitudinal timeline of compliance scores, pharmaceutical regimen (with highlighted changes), and major healthcare events. In reviewing this multi-dimensional data over time, Dr. Jones identified several interesting observations:

1) While the overall trend of compliance scores had declined over the past 2 years, the reported decline was far greater for Dr. Harrison than other reported healthcare providers (raising the concern for individual provider bias).

2) Two major medical events were associated with substantive declines in compliance. The first was a stroke which occurred 18 months ago and the second was a change in one of the oral diabetic medications.

3) An external event (death of a close friend) was associated with a sudden occurrence of missed appointments to multiple healthcare providers.

After reviewing these trends, the medical records, and conversing with Mrs. Smith and her daughter, Dr. Jones came up with the following recommendations which he discussed with Mrs. Smith:

1) The relationship with Dr. Harrison had declined to the point that an effective physician-patient relationship was no longer viable. In order to maintain an excellent working relationship, Dr. Jones recommended that they communicate weekly to discuss medical problems, treatment planning, diet, and psychosocial issues.

2) The stroke was likely associated with some change in cognition and affect, which collectively had an adverse effect on compliance. Dr. Jones was going to have Mrs. Smith work with a memory specialist to assist with the daily activates of living including pharmaceutical dosing. In addition, Dr. Jones was going to offer Mrs. Smith an anti-anxiety medication which she could take on an “as needed” basis.

3) Continuous monitoring of blood glucose was an essential component to long term health and optimization of pharmacology. Dr. Jones was going to ask Mrs. Smith to utilize home health technology to record daily blood glucose measures and the two of them would review this data weekly in order to ensure that therapy has been optimized.

4)The oral medication associated with a decrease in compliance has a side effect of memory impairment, and as a result Dr. Jones was going to consult with the endocrinologist to replace this specific medication.

5) The death of the close friend had two negative impacts on Mrs. Smith including the emotional loss of a loved one as well as the loss of transportation. Dr. Jones was going to assist Mrs. Smith in having all pharmaceutical orders electronically monitored (e.g., scheduled renewal times), and have the pharmacy of her choice deliver new prescriptions directly to her residence.

Six months after initiating these changes Dr. Jones observed a noticeable improvement in Mrs. Smith demeanor, overall compliance, and blood glucose levels. While these were in part due to a poor working relationship with the previous PCP Dr. Harrison, a number of other factors were believed to be contributory. The net result is that patient compliance is a critical determinant in healthcare outcomes and can only be reliably understood if standardized compliance measures are recorded and analyzed by the program 110 in conjunction with a wide array of variables attributable to the patient, provider, technology, and pharmacology regimen. The ability of the program 110 to correlate multiple components of the Pharmaceutical database 113, 114 with one another over time (i.e., longitudinal multi-factorial analysis), provides greater insight as to causation and effect of intervention.

In the above example cited with respect to compliance analysis, the recording of compliance data by healthcare providers was assumed to be on the basis of manual data input. In actuality, the recording of Patient Profile data is not solely dependent upon healthcare provider manual input alone, but can in some situations be automated as new data is recorded by the program 110 in the patient electronic healthcare record. If for example, a patient does not pick up a newly prescribed medication at the pharmacy of record or fails to refill a continuous medication at the appropriate time, an automated record by the program 110 of “noncompliance” may be manually recorded by the pharmacy staff or automatically recorded by the program 110 in the pharmacy information system.

In either case, this documentation of noncompliance, would in turn trigger an automated data update by the program 110 to the Patient Profile. In one embodiment, once this data is automatically recorded by the program 110 in the appropriate compliance metric (i.e., adherence to prescribed regimen), a modification by the program 110 to the corresponding compliance score may take place depending upon the frequency and severity of the recorded compliance outlier. The relevant healthcare providers (e.g., ordering physician, pharmacist of record) would be sent an automated alert by the program 110 notifying them of the compliance event with an electronic link to the Patient Pharmaceutical Profile database 113, 114. They would then have the option to update and/or modify the existing compliance data. In the event that this update resulted in a modification by the program 110 to the patient compliance score, an additional data verification step would be required by the program 110 (which may require multiple stakeholders input), to ensure data accuracy. The revised data compliance score would in turn trigger an automated alert by the program 110 to all identified healthcare providers, to provide them with an opportunity to modify existing pharmaceutical orders and treatment plans if needed.

In one embodiment, as data is continuously collected over time by the program 110, it would be expected that individual and collective compliance scores for an individual patient may show variation, commensurate with commonplace changes which occur over a patient's continuum of care. As an example, a patient may begin to demonstrate cognitive impairment resulting in memory deficiency, which will likely adversely affect their collective compliance score by reducing a number of individual compliance metrics (e.g., adherence to prescribed regimen, maintaining scheduled appointments, reporting of healthcare changes). As temporal changes to the individual patient's compliance scores are recorded over time by the program 110, two unique functions of the invention's database can be derived.

In one embodiment, first, selected healthcare providers can be automatically notified of these changes in compliance once they are documented and verified. This provides an automated method of continuously updating healthcare providers as to individual patients' health status changes, which in turn may warrant changes to their healthcare delivery strategies and pharmaceutical regimens. Secondly, in one embodiment, changes to an individual patient's compliance score over time may result in a categorical change to their defined profile group. As an example, a patient may have an initial profile score of 37, based upon the 10 metric analysis shown above. Over time, this collective compliance score may decrease to 34, based upon temporal changes in patient compliance. While this collective compliance score may be relatively small, it may result in the program 110 reclassifying the individual patient from one compliance profile category (e.g., Intermediate Compliance) to another profile category (e.g., Low to Intermediate Compliance) based upon statistical analysis of the larger patient population. This use of statistical analysis of the Patient Pharmaceutical Profile database 113, 114 by the program 110 provides a method for correlating statistical trends and outcomes analyses of larger patient populations with individual patient profile scores. In one embodiment, the goal is to create a dynamic data-driven system for continuously updating and refining patient care strategies based upon individual patient changes and determining how these changes correlate with larger patient population profile groups.

In one embodiment, just as an individual patient compliance score may decrease over time with age, compliance scores may also increase over time, with proactive intervention. Customized educational programs, use of supporting technology, and allocation of responsibilities to a designated caretaker may all result in improved compliance scores, which may affect overall pharmaceutical strategy. A patient with a previously low compliance score (e.g., collective score of 22 out of a possible 50), may have been prescribed a “safer” and less effective antihypertensive medication out of concerns of missed and/or erroneous dosing. With an improved compliance score of 36 (resulting from intervention), the patient is now placed in a different compliance profile group category, which calls for alteration in the prescribed medication to the more effective antihypertensive medication, which may have a more onerous dosing regimen and therefore require greater patient compliance. Since the newer drug has a lower safety profile (but higher clinical response) then the previous drug, the ordering physician may request heightened scrutiny and documentation of dosing for the initial month of treatment to ensure that compliance is maintained. This ability for “heightened surveillance” and subsequent data analysis is another attribute of the invention, which is aimed at continuously monitoring changes in both the pharmaceutical regimen and individual patient status.

In one embodiment, the ability of the program 110 to incorporate different levels of pharmaceutical surveillance is another unique feature of the present invention. As increasing levels of surveillance are required, additional and more rigorous data may be required for analysis. At lower levels of surveillance, requirements may include the program 110recording the identities and dosing schedules of each pharmaceutical of record. As the level of scrutiny increases, additional data points may be required including (but not limited to) documentation of provider-patient communication, associated clinical tests (e.g., liver enzymes in a drug associated with hepatic dysfunction), completion of requisite educational programs, home health data measurements (e.g., blood glucose, blood pressure), reporting of side effects, and verification of drug ingestion.

In one embodiment, these surveillance measures can be adjusted periodically by the program 110 in accordance with provider concerns and changes in patient compliance. At the same time (and perhaps most importantly), each individual pharmaceutical agent can have its own surveillance requirement, which takes into account historical compliance measures, pharmaceutical risk profile, and clinical status of the patient. As an example, a patient may be started on a recently approved drug for depression, which has an increased incidence of side effects relative to their previous anti-depression medication. While the patient's compliance score has been consistently high (i.e., 42 out of a possible score of 50), the physician is concerned about the increased possibility of side effects and the change in medication regimen. As a result, the physician selectively modifies surveillance requirements for the new anti-depression medication without changing the surveillance requirements on the other established pharmaceuticals. The physician elects to continue this heightened surveillance for the first 3 months of therapy and revert to the baseline level of surveillance afterwards, assuming no compliance issues are identified during the first 3 months of treatment. After entering this surveillance/compliance data into the Pharmaceutical Database 113, 114, the physician requests weekly compliance and administration reports specific to the pharmaceutical in question, from the program 110. In addition, the physician requests that the program 110 implement an automatic change in surveillance be incorporated after 3 months if no negative pharmaceutical administration and/or compliance data is recorded. This illustrates the ability to selectively adjust pharmaceutical surveillance while also incorporating automatic modifications based upon longitudinal data analysis.

Outcomes Analysis and Automated Decision Support

Another important feature of the invention is to correlate patient profile categories with clinical outcomes analysis. In one embodiment, the underlying rationale for creating these profile groups is to identify similarities and trends between individual patients which can ultimately be used to predict clinical outcomes, based upon longitudinal analysis of the larger group. If one reviewed the category of Compliance for classifying individual patients into broader categorical groups, one may do so in a variety of ways.

In one embodiment, classification would be on the basis of individual compliance metrics (e.g., adherence to prescribed regimen, participation in educational initiatives). Patients who rate at the highest levels for either of these individual compliance metrics would be expected to have the best clinical outcomes over time, since clinical outcomes are in large part dependent upon patient therapeutic compliance and education. While this correlation between patient compliance and clinical outcomes may prove accurate in the broad sense of healthcare delivery, it may differ depending upon specific disease states and pharmaceutical regimens.

For example, a short term pharmaceutical regimen used for the treatment of a straightforward and acute disease process (e.g., urinary tract infection) may have a weaker correlation between compliance and clinical outcomes than a long term pharmaceutical regimen for a chronic disease process (e.g., hypertension). At the same time, one antihypertensive medication may be less affected by patient compliance (i.e., adherence to prescribed regimen) then another, based upon the variables such as the dosing schedule and half-life of the medication.

In addition, the relationship between compliance and clinical outcomes may be affected by disease severity, where smaller differences in patient compliance have more profound effects in clinical outcomes when the disease severity exceeds a certain clinical threshold (e.g., diastolic blood pressure >100 mm Hg). This illustrates the dynamic nature of patient compliance, clinical status, pharmaceuticals, and clinical outcomes. It is only through the creation of large standardized databases and statistical analysis of large patient populations that one can begin to understand the complex relationship between individual patients attributes (e.g., compliance) and clinical outcomes. The present invention provides a mechanism to accomplish this task while identifying individual and collective profile variables which have the highest correlation (based upon statistical analysis) with clinical outcomes.

In one embodiment, in addition to using the profile group categories to predict clinical outcomes (i.e., response to pharmacologic treatment), the profile groups can also serve a number of other purposes. Creation of decision support tools, best clinical practice guidelines, and customized educational programs are all predicated on the ability to tailor intervention based upon specific patient characteristics, which is the fundamental premise behind personalized medicine. In the prior example of treatment of hypertension, a physician has an excessive number of potential drug therapies (both individually and in combination), which are often decided upon based upon the individual physician's clinical experience and education/training, which is often affected by recent continuing medical education (CME) seminars, consultations with pharmaceutical company representatives, and scientific publications.

While abundant educational and clinical resources are readily available, the majority of healthcare providers tend to rely on their individual frame of reference, which is frequently limited to a finite number of pharmaceutical options. By creating a standardized database 113, 114 where a program 110 tracks clinical outcomes in accordance with disease, pharmaceutical options, and patient profile characteristics, the present invention creates the ability to optimize therapeutic strategy in accordance with the collective experience of large patient populations with shared clinical, demographics, educational, socioeconomic, and compliance attributes. By using a multi-variant analysis of the databases 113, 114 automated decision support tools of the program 110 can be created which factor in numerous variables (e.g., disease state and severity, prior pharmacologic history and risk factors, patient compliance, economic and insurance related restrictions) to arrive at a hierarchical listing of pharmacologic treatment options which are best suited to the individual patient (as opposed to the provider experience and education).

In one embodiment, other patient profile categories are contained with the standardized Patient Pharmaceutical Profile and play a fundamental role in classifying and categorizing patients into different profile groups. These profile groups and the individual variables contained within them can play an important role in decision support, clinical outcomes, technology utilization, educational strategy, and applications aimed at improved pharmaceutical delivery.

As noted above, in one embodiment, the five major categories contained within the Patient Profile schema are Demographics, Education, Clinical, Socioeconomic, and Compliance. Since Compliance has been previously discussed in detail, focus will now turn to other 4 categories and illustrate their utility.

In one embodiment, the Demographics category is fairly straightforward and contains standardized data which defines the patient's vital characteristics. As it relates to pharmaceutical administration and selection, age plays an important role, for it often serves to correlate to the inherent risks and adverse events which can occur with pharmaceutical administration. Pharmaceutical agents associated with higher risks for various organ dysfunctions (e.g., liver, kidney) tend to have lower safety profiles in very young and elderly patients. Other demographic variables, such as ethnicity and religion, may play unexpected roles in optimizing pharmaceutical selection, administration, and education, due to associated cultural mores, which define acceptable behavior. In addition, ethnicity may play an important role in genetics, which often affects a given pharmacologic agent's safety and treatment profile.

In one embodiment, the profile category of Education is important for it can often define an individual patient's intellectual capacity, healthcare literacy, and openness to novel or non-traditional treatment options. At the same time, patients with higher levels of education are commonly more interested in obtaining greater amounts of educational material related to their disease and treatment, and taking an active role in healthcare decision making (i.e., patient empowerment). This can serve as an important barometer in how healthcare providers should communicate with patients and engage them in the decision making process, as well as soliciting their input and feedback related to side effects, complications, and disease response.

Pharmaceutical regimens associated with clinically significant and/or frequent side effects require knowledge that the accurate and reliable clinical data is being monitored, communicated, and promptly treated. In order to accomplish this and be confident in prescribing more aggressive therapies, it is important that the healthcare provider and patient actively communicate and effect prompt intervention in the event of an adverse action.

A frequently overlooked yet important variable within the Education category is computer proclivity, which takes on heightened importance in the current environment of digital medical practice, electronic data collection and monitoring, and communication. In addition to patients having the ability to electronically access their medical records, this variable plays a fundamental role in strategizing optimal means for provider-patient communication, education, and data display. A patient who is technologically savvy would likely be more accepting of electronic forms of communication and data display, whereas a patient with less computer proclivity would feel more comfortable and prefer traditional analog forms of communication. These differences in technology proclivity need to be factored by the program 110 into creating an optimal strategy for pharmaceutical data display, recording, tracking, analysis, and feedback.

In one embodiment, the Clinical category of the patient profile is of critical importance because it provides a snapshot of the patient's overall clinical status, which entails a large number of patient-specific clinical variables including prior medical/surgical history, active medical problems, morbidities and physical limitations (e.g., eyesight, hearing deficit, physical impairment), current and past pharmaceutical regimen, genetics, allergies and drug-related adverse actions, organ system dysfunction (and related laboratory data), diet, and physical size (e.g., height, weight, body mass index). While the previously discussed categorical data variables readily lend themselves to data standardization, standardization of clinical data is a bit more challenging.

While conventional practice routinely records clinical data using free text and narrative prose, the present invention provides a methodology for an alternative standardized data system, using a scaled Likert grade (1-5) for each of the individual clinical variables. This provides a method for quantifying an individual patients' clinical profile in a manner similarly described for patient compliance. A higher clinical score would correlate with a higher degree of optimal health, while a lower score would be associated with a poorer degree of health. A representative model for how the clinical profile variables can be quantitatively standardized is presented below.

The variables for the quantitative modeling of the Clinical Profile include: 1) medical and surgical history; 2) active disease and organ system dysfunction; 3) cognitive level; 4) sensory and motor skills; 5) genetics; 6) diet; 7) body habitus; 8) age; 9) drug side effects and adverse reactions; and 10) pharmaceutical regiment.

The Likert Scale 1-5 is as follows: Highest level of impairment and/or risk: 1; Lowest level of impairment or risk: 5.

In one embodiment, the present system creates a mechanism for standardizing data (which in turn provides for creation of a referenceable database 113, 114 which can be used for data mining and statistical analysis), create a method for dynamically modifying data as changes in clinical status occur, create an easy to use and understand numerical system which provides categorization of patients on both individual variable and collective levels, and provide a customizable method for preferential weighting of individual variables.

To illustrate how the Clinical Profile would be used in practice, an example is as follows. A patient has recently suffered from acute diverticulitis, which resulted in colonic perforation, emergent surgery, and a prolonged hospitalization with several complications. At the time of discharge, the patient has a new pharmaceutical regimen, dietary restrictions, and organ dysfunction (i.e., renal insufficiency resulting from antibiotic-related toxicity). Before this medical event, the patient had a cumulative Clinical Profile score of 32 (out of a possible 50). Unfortunately, the changes in the patient's clinical status has negatively modified this collective score to 24 based upon reduced scores for the clinical variables of surgical history, active problem list, diet, adverse drug reactions, and organ system dysfunction. As a result, this reduced Clinical Profile score has the program 110 placing the patient in a higher risk profile group (based upon statistical analysis and categorization of the data).

In this example, one specific clinical profile variable (i.e., active disease and organ system dysfunction) takes on greater importance than other variables due to the fact that the recent onset of renal insufficiency will have a direct effect on pharmaceutical selection and dosage, since many pharmaceuticals are excreted through the kidneys and therefore dependent upon renal function. As a result, this specific variable may require preferential weighting in the overall patient profile analysis by the program 110, and the pharmaceutical decision making.

This selective weighting can be accomplished in a variety of ways. In one embodiment, the program 110 can utilize a higher multiplier to the individual variable of increased clinical importance, which will have the effect of providing greater significance to that specific variable in the categorization of the Patient Clinical Profile relative to the overall population of patients within the collective pharmaceutical database 113, 114.

In another embodiment, the program 110 can selectively prioritize and analyze that specific variable, so that analysis of the collective pharmaceutical database 113, 114 will select out patients which have comparable measures for that specific variable.

In this manner only those patients with similar active disease/organ system dysfunction profile scores will be used in the comparative analysis by the program 110 for determination of best practice guidelines and pharmaceutical decision making. This ability of the present invention to selectively prioritize individual variables in pharmaceutical analysis provides healthcare providers with the ability to customize pharmaceutical decision support.

The ability of the program 110 to use individual and collective variables from the Clinical Profile database 113, 114 to assist in pharmaceutical decision support may have an effect on a number of healthcare related variables including (but not limited to) insurance payment, guidelines and recommendations for pharmaceutical administration (e.g,. selection of pharmaceuticals in association with reduced renal capacity and increased morbidity), requisite educational support, requirements for consultation with healthcare specialists (e.g., dietician, nephology, visiting nurse), technology (e.g., home monitoring of fluid intake, temperature, urine), and patient-provider communication. If and when the patient's clinical status was to improve and allow their Clinical Profile scores to return to the pre-hospitalization baseline, then many of the clinical care modifications could be accordingly adjusted by the program 110. Thus, the present invention provides a number of advantages over conventional practice.

Firstly, clinical care decision-making is made on the basis of data-driven best practice guidelines which take into account the individual patient's clinical status and correlates this with those of comparable patients. Secondly, the patient and clinical care providers are provided with tangible data-driven incentives and goals with which to direct medical planning and measure success. Thirdly, well defined economic incentives are provided which reward patients and clinical care providers to improve clinical outcomes on the basis of the individual, patient's performance goals, treatment plans, and baseline clinical status.

Healthcare Provider Profiles

In one embodiment, while the Patient Profile provides an objective methodology for categorizing individual patients into different “risk groups”, a similar approach can be taken with individual healthcare providers. A wide variety of healthcare providers play roles in pharmaceutical decision making and administration, including but not limited to, physicians (both primary care and specialists), pharmacists, nurses, dieticians, technologists, information technology specialists, and support staff. The ability of these various providers to carry out their professional duties relating to pharmacology is in large part dependent upon a number of individual professional and personal attributes including (but not limited to) education and training, clinical experience, technical proficiency, technology access and proclivity, communication skills, personality, and compliance.

Provider Profiles entered into the database 113, 114 include the following information:

A. Education: 1) Professional Education (including subspecialty training); 2) Credentialing and Licensing; 3) Certifications; and 4) Continuing Education Programs.

B. Clinical Experience: 1) Practice Type; 2) Geographic Location; 3) Years in Clinical Practice; 4) Hospital Affiliations; 5) Patient Population Served.

C. Technology Utilization: 1) Access to Technology; 2) Computer Proclivity; 3) Information System Technology; 4) Decision Support Software.

D. Communication: 1) Patient Communication; 2) Reporting and Documentation; 3) Support Staff Oversight; 4) Patient Education; 5) Peer Consultation.

E. Personality: 1) Agreeableness; 2) Conscientiousness; 3) Openness; 4) Emotional Stability; 5) Expressiveness.

F. Compliance and Performance: 1) Adherence to Professional Guidelines; 2) Practice Performance Metrics; 3) Assessment of Drug Interactions; 4) Ordering Appropriateness; 5) Treatment of Adverse Actions; 6) Security and Storage of Controlled Substances; 7) Policies and Procedures; 8) Quality Assurance and Quality Control.

In one embodiment, the concept of classifying and categorizing providers into different groups based upon individual attributes and proficiencies provides an objective method for determining clinical expectations, best practice guidelines, and decision support requirements.

In order to illustrate how the Provider Profile would be created by the program 110 and used for pharmaceutical analysis, the following examples look at 3 different primary care physicians (Drs. X, Y, and Z).

Dr. X: 35, recently trained, computer savvy, highly conscientious but not very verbal in face-to-face communication (prefers electronic communication), keeps up with the recent medical developments through on-line CME and review of medical journals.

Dr. Y: 65, hands on highly communicative, not computer savvy, proactive in patient education, doesn't keep up with latest medical developments, extremely patient focused, uses pharmaceutical companies as primary source of learning.

Dr. Z: 54, busy practice seeing 100 patients per day, highly focused on workflow, often abrupt with patients, delegates a lot of responsibility to staff, patient education and communication largely done through nurse, invests in latest technology including decision support.

Based upon these descriptions it becomes apparent that differences in personality, communication styles, education and training, technology utilization, and workflow will result in stark differences in the manner in which each physician interacts with their patients and arrives at clinical decision making. Dr. X is highly technology dependent, embraces self-learning, and prefers indirect methods of patient communication and education. As a result, Dr. X is highly adept at keeping up with the latest changes in medical practice and best practice guidelines and utilizes a broad spectrum of pharmaceuticals in everyday practice.

Dr Y, on the other hand is old fashioned and prefers face to face communication with his patients, to whom he relegates large amounts of time. While he struggles to keep up with new advances in pharmaceutical practices, he compensates by sticking with a small array of drugs he has vast experience with, and relies on local pharmacy colleagues for consultation.

Dr. Z takes a hands-off approach to patient interactions, relying on his nursing staff to assume a great deal of responsibility relating to patient communication, education, and follow-up care. Since workflow and productivity take on heightened importance to Dr. Z, he relies on computerized information system technology and decision support tools in his practice to assist in data retrieval, analysis, and decision making. While he may not be as personal as other physician colleagues, he is adept and highly efficient.

The net result of these differences in skill sets, personality, communication, practice style, and technology utilization have profound effects on the manner in these physicians' practice, specifically as it relates to pharmaceutical decision-making, patient communication, education, and follow-up care. Some patients prefer the paternalistic approach of Dr. Y, others the more cerebral and computer savvy approach to Dr. X, and others the no-nonsense “cut to the chase” and highly efficient approach to Dr. Z.

Now let's revert to the previously cited example of Mrs. Smith who had compliance issues due to a combination of interpersonal issues with her initial PCP, loss of transportation, and failure to fill prescription orders. If one were to correlate the individual physician profiles of Drs. X, Y, and Z with Mrs. Smith's profile, we would begin to gain insight as to predicting the best patient-physician profile fit. Dr. Z would likely represent the poorest physician option based upon his profile, since would unlikely to be attentive and devote the required time to the complexity of Mrs. Smith's clinical problems and also be viewed as indifferent to Mrs. Smith's emotional needs.

Dr. Z could compensate for his profile deficiencies by utilizing nursing staff for greater patient communication and education needs while utilizing technology to assist in data tracking and analysis, which would be an integral component to optimizing health care for Mrs. Smith given the fact that she has a number of chronic and potentially debilitating medical problems including coronary artery disease, diabetes, hypertension, stroke, and peripheral vascular disease.

While on the surface Dr. Y would appear to be the best patient-physician profile fit due to his high degree of patient compassion and communication skills, there are some professional concerns. Dr. Y's limitations in keeping up with medical advances (and newer pharmaceuticals) coupled with his lack of computer utilization could result in substandard decision making, which takes on heightened importance given Mrs. Smith's multitude and seriousness of medical problems. If Dr. Y was to be successful as a physician to Mrs. Smith, he would likely require greater assistance from professional resources, which could include pharmacists, physician subspecialists, pharmaceutical sales representatives, and computerized decision support software.

Dr. X surprisingly may be the best choice for Mrs. Smith based upon the patient and physician profiles. Being recently trained, having high computer literacy, and aggressively keeping up with newer advances in therapy, Dr. X would have the required skill set and knowledge to successfully deal with Mrs. Smith's complex medical issues. While somewhat lacking in face-to-face communication skills, Dr. X is excellent at electronic communication. If Mrs. Smith was comfortable and willing to embrace computerized communication (e.g., e-mail, text messaging, on-line chat), the end result could be quite positive. Only by understanding the inherent strengths and weaknesses of each participant (both patient and provider), can an informed decision and effective collaboration strategy be made, which benefits the patient and their specific healthcare needs and preferences.

In the present invention, the use of provider profile data creates a number of unique opportunities, which are not readily available in conventional medical practice. As illustrated in the example above, the cross-referencing of provider and patient profiles can serve as a method for provider selection. This proactive tool for provider selection (in accordance with the patient's profile) can be done in isolation or combination.

An example of “combined” provider selection could be seen in the case of Dr. Y, where his relative weakness of recent medical advances requires additional professional resources for compensation. If Mrs. Smith was to select Dr. Y as her PCP, the patient-provider profile analysis would suggest that external professional resources be incorporated into the provider care plan and may include pharmacist, dietician, endocrinologist, and cardiologist. The optimal pharmacist profile would be one which has strong attributes of continuous learning, physician consultation/communication skills, and technology utilization, since these are skills which would be the most complementary to Dr. Y's deficiencies. This illustrates how provider profiles of the present invention can be used in isolation or combination to affect optimal patient care.

In addition to provider selection, the provider profiles and derived data of the present invention can provide a host of additional benefits for optimizing clinical outcomes and patient satisfaction. Providers can gain valuable insight as to their relative strengths and weaknesses, which in turn can assist with ongoing education and training (i.e., continuing medical education (CME). As these educational resources are used, the provider profile data can be continuously updated by the program 110 to reflect the improvements gained. The provider profile therefore becomes a dynamic form of analysis, providing ample opportunity for providers to enhance their profile through professional growth.

In the same manner, relative deficiencies in individual provider profile variables can also be addressed through technology advances. If, for example, a physician is demonstrating relatively poor outcome measures for the treatment of hypertension, both educational and technology resources may be sought after by the program 110 for targeted improvement. Computerized pharmacy decision support tools may be shown to provide an excellent resource for pharmaceutical selection and comparative analysis by the program 110. If the provider either does not have access to this software or has deficient computer skills, he/she may elect to invest the time and money to acquire both the requisite computer skills and software for professional improvement. The derived performance and compliance analytics can be calculated by the program 110 on both general and disease-specific bases.

In the example provided, Dr. Y may have scores for the metric “Adherence to Professional Guidelines” for diabetes and stroke, but poor scores for hypertension. Having the ability to analyze disease-specific data for an individual provider creates the ability to target specific clinical deficiencies which are of greatest benefit to the specific patient population being served.

The example provider profile provided above was limited to that of primary care physicians. However, the constructs of the Provider Profile can easily be modified to accommodate a variety of healthcare providers including (but not limited to) nurses, physician specialists, physician assistants, pharmacists, dieticians, technologists, and support staff (including pharmaceutical sales representatives which play an important role in education). The point to be made is that while these profiles offer unique benefits, their value becomes synergistic when used in combination (e.g., Patient and Provider Profiles). In the end, clinical outcomes are often determined by the “weakest link in the chain”. Unless all profiles are considered and accounted for, the opportunity for proactive improvement is minimalized.

Patient Feedback and Provider Communication

In one embodiment, the program 110 of the present invention has the ability to record, analyze, and intervene in care delivery based upon patient feedback and patient/provider communication. Data components related to feedback and communication described herein, can be recorded using both standardized and free text data formats. As previously stated, one advantage of standardized data collection is that it provides the ability to create a referenceable database 113, 114, in which data can be comingled and analyzed over large and diverse populations of patients and providers. The ability of the program 110 to fractionate this data based upon patient and provider profiles creates a unique method of data analysis, in which data can be examined as it relates to similarities among the groups of interest, which in turn can create best practice targeted best practice guidelines.

These targeted best practice guidelines could focus on any one of the multitude of data elements described in the invention including (but not limited to) a specific disease process, class of pharmaceuticals, patient compliance level, technology utilization, and provider communication skills. One would also have the ability to combine individual data elements in an analysis to determine best practice guidelines for greater specification. As an example, one may wish to determine best practice guidelines for pharmaceutical selection as it relates to a specific disease (e.g., diabetes), patient demographic (e.g., white females age greater than 65 years old), and provider profile characteristic (e.g., PCP with limited technology utilization and computer proclivity). By having the program 110 record data in a standardized format, one could theoretically combine data from multiple data repositories, thereby creating the ability to perform large sample size statistical analysis.

When evaluating patient feedback, a wide array of feedback data can be collected, including (but not limited to) self-reporting of pharmaceutical administration, pharmaceutical therapeutic response, medication related side effects and adverse actions, perceived value of educational initiatives, utilization of technology and ease of use, lost or stolen medications, satisfaction of individual provider care delivery, and out of pocket pharmaceutical cost. By the program 110 tracking this data over time, one creates the ability to perform trending analysis as well as identify individual data outliers which could serve as a focal point for more intensive investigation.

As an example, a patient's self-reported pharmaceutical administration has consistently (i.e., over a 2 year period of time) correlated with objective measures recorded by the supporting technology. Suddenly, the self-reported administration data becomes inconsistent relative to the objective data measurements and does so for all pharmaceuticals being prescribed. This data outlier is clearly unique for the patient and inconsistent with historical data, with the program 110 alerting the provider that an acute problem has occurred. In further investigation, it is found that the patient has experienced acute short term memory loss which may be the result of an occult stroke, which did not impair motor function and was therefore not clinically overt.

Another example can illustrate how the feedback data can be used by the proram 110 to customize patient care delivery and assist in creating targeted best practice guidelines. Suppose in this example, the patient has experienced difficulty and frustration using supporting technology (e.g., a smartwatch), which has been provided for the purpose of automated dose alerts and identification of medications (i.e., using a color coded schema for each different medication). The PCP in consultation with an information technology specialist has provided the patient with a series on educational programs (both in analog and on-line formats) to assist with learning to use the new technology. The patient has consistently reported frustration and poor “ease of use” scores for the technology in question. Shortly after completing one of the recommended educational programs (e.g., large print pamphlet with color coded graphics), the patient begins to record higher objective compliance and subjective satisfaction scores for the technology in use. This suggests that the educational programs provided to the patient were utilized by the patient and deemed to be successful.

After further in-depth communication, the PCP realized that one specific educational program was primarily responsible for the dramatic improvement. As a result, the PCP recorded this information in the patient database 113, 114 with the recommendation that future technology focus educational programs on printed text with graphics. This patient-specific educational feedback was also recorded by the program 110 in the Patient Profile database 113, 114, so it could be of use for patients with similar profile characteristics.

In one embodiment, another method of recording patient feedback data is in the form of speech. Speech (or voice) recognition technology has been utilized and adopted throughout a variety of applications, including healthcare. By incorporating speech recognition technology into the program 110 (and corresponding database 113, 114) a number of unique features can be realized, apart from traditional data recording. One of these unique applications is the ability to create individual Speech Profiles for each individual end-user (e.g., patient, caretaker, and providers). The creation of these user-specific speech profiles by the program 110 would provide the means with which to identify and authenticate each individual end-user attempting to access the Pharmaceutical Database 113, 114 with their own unique established speech profile, thereby providing an alternative to conventional biometrics for end-user verification.

In addition, these user-specific speech profiles could also provide an objective method for measuring stress and alteration from baseline clinical status. If, for example, a patient was to experience an acute illness like the flu, the resulting analysis by the program 110 of their speech profile would identify an alteration from baseline, which would provide for the ability to create an automated prompt or alert to the designated healthcare providers alerting them of the change in patient health. If the alteration in speech pattern was to exceed a predefined threshold, then an automated consultation could be triggered by the program 110 which formally mandates a provider-patient consultation for in depth analysis.

In addition, longitudinal analyses of users' speech profiles by the program 110 could create a computerized database 113, 114 of specific speech pattern alterations for the purposes of automated speech analysis and diagnosis. As an example, a patient who was to suffer an acute stroke involving the speech motor center of the brain may incur a specific pattern of slurred speech which alerts the primary care physician of concern for acute stroke. Alternatively, a patient who has recently ingested a large quantity of alcohol or sedatives may have a different pattern of slurred speech, which may if severe enough, could have the program 110 trigger an alert to the primary care physician or designed caretaker for further investigation. If this particular patient had a pre-existing history of pharmaceutical overdose or attempt at suicide, the ensuing alert may be of higher criticality, given the unique Patient Profile and clinical history. This illustrates how speech analysis of the patient can serve as an additional resource for data input, end user identification, and real-time clinical analysis.

In one embodiment, patient-provider communication is an integral component of the program 110 of the present invention, and the resulting Pharmaceutical Database 113, 114. Since patients' pharmacologic regimens are dynamic in nature and subject to continuous change, it is important that one create a reproducible system for continuous monitoring, analysis, and communication. A number of data related to patient-provider communication can be recorded and analyzed by the program 110 relating to pharmaceutical administration, treatment planning, testing, intervention, and education. Each time a provider, patient, or caretaker initiates a communication a registration process is required by the program 110 which serves to identify the party, provide a date/time stamp of the action, and record all subsequent data in the Patient Pharmaceutical Database 113, 114. Any resulting modifications to the existing pharmaceutical or clinical patient record would require formal verification and acknowledgment by all involved parties (which is recorded by the program 110 in the database 113, 114), along with an automated record of all resulting orders to the patient medical record. Examples of these automated order entries could include new or modified provider appointments, new (or cancelled) orders for tests, prescription changes (new, modified, cancelled pharmaceutical orders), or consultation requests.

Since requests for communication do not always take place immediately, it is common for a time delay to occur between the communication request and actual occurrence. Since it is important that all communications be accounted for acted upon, the program 110 of the present invention maintains a date and time-stamped record of all communication requests, responses, and subsequent actions. At the time each communication is transmitted, the sender has the ability to prioritize the communication (using a scaled communication schema), categorize the nature of the communication, request receipt confirmation, specify the time urgency for response, and provide date and time options for direct communication (e.g., openings in a daily calendar). An example of a scaled communication schema is as follows:

1: Low Importance, Follow-up requested within 72 hours.

2: Moderate Importance, Follow-up requested within 24 hours.

3: High Importance, Follow-up requested within 12 hours.

4: Emergent, Follow-up requested within 2 hours.

5: Highly Emergent, Follow-up requested within 30 minutes.

Once the Communication application of the program 110 is activated, the following sequence of events and data is recorded:

1) Identity of the End-Users sending and receiving the communication.

2) Classification of the communication.

3) Prioritization of the Communication including response time requirement.

4) Receipt Acknowledgment (with an automated escalation pathway if not successful within the designated time frame).

5) Communication Response.

6) Follow-up Actions.

In one embodiment, if receipt acknowledgement and/or a response is not received in the designated time frame, the program 110 will activate an automated escalation pathway which is of particular importance for Emergent and Highly Emergent communications. This provides an alternative communication schema based upon the type of communication, designated back-up users, and degree of urgency. For non-responding providers, the program 110 may contact the designated back up provider (e.g., on-call personnel, department chief, administrative supervisor). For non-responding patients, the program 110 in the automated escalation pathway, may contact a designated family member, caretaker, or patient advocate. The purpose of this scaled escalation communication schema is to ensure that all communications are accounted for in a timely and clinically appropriate manner. In the event that certain individuals fail to honor their obligations on a repeated basis, intervention may be required.

When follow up actions result from the communications, then direct links to the electronic medical record are recorded in the Pharmaceutical Database 113, 114. Examples of communication follow-up actions include (but are not limited to) pharmaceutical orders (e.g., new medication, adjustment of dosage), orders for clinical testing (e.g., laboratory or medical imaging tests), scheduled appointments (e.g., physician office visit), and consultations (e.g., dietician, subspecialist physician).

Thus, it should be emphasized that the above-described embodiments of the invention are merely possible examples of implementations set forth for a clear understanding of the principles of the invention. Variations and modifications may be made to the above-described embodiments of the invention without departing from the spirit and principles of the invention. All such modifications and variations are intended to be included herein within the scope of the invention and protected by the following claims.

What is claimed is:

1. A computer-implemented method of tracking pharmaceuticals, comprising:
receiving data on a plurality of participants and a plurality of pharmaceutical agents in a registration process, and storing said data in a database of a computer system;
receiving input on a pharmaceutical agent for an individual participant and storing said input on said pharmaceutical agent in said database;
displaying on a display of said computer system, a timeline for said individual participant, summarizing a pharmaceutical history of said individual participant for all pharmaceutical prescriptions and pharmaceutical agents stored in said database;
analyzing data in said database, using a processor of said computer system, wherein on condition that said pharmaceutical agent is one of said plurality of pharmaceutical agents, and on condition that said individual participant is one of said plurality of participants, determining a clinical appropriateness of said pharmaceutical agent for said individual participant;
displaying, on a display of said computer system, default data from said database on said pharmaceutical agent, to complete standardized data fields on said pharmaceutical agent for said individual participant; and
verifying that said completed data fields on said pharmaceutical agent for said individual participant are consistent with industry standards and clinical guidelines.

2. The method of claim 1, further comprising:
notifying a health care professional of any discrepancy in said completed data fields, from said industry standards and said accepted clinical practice, using electronic means; and
forwarding alternative or corrective options to said healthcare professional using said electronic means, that would modify said completed data fields and obviate said discrepancy.

3. The method of claim 1, wherein said healthcare professional can one of accept said default data in said standardized data fields in a pharmaceutical order, and complete said registration process, or modify said default data in said standardized fields in accordance with clinical requirements of said healthcare professional.

4. The method of claim 3, wherein on condition that said healthcare professional does not accept said alternative or corrective options, requiring an audit of said default data and a quality assurance review of said data in said pharmaceutical order by another healthcare professional, to obtain consensus between said healthcare professional and said another healthcare professional.

5. The method of claim 4, wherein on condition that consensus is not reached between said healthcare professional and said another healthcare professional, said healthcare professional may override any modifications in said pharmaceutical order regarding said discrepancy.

6. The method of claim 5, wherein on condition that consensus is achieved between said healthcare professional and said another healthcare professional, recording a result of any audit, and completing said registration process with any modifications in said pharmaceutical order.

7. The method of claim 5, wherein on condition that any said modification in said pharmaceutical order are overridden regarding said discrepancy by said healthcare professional, and said pharmaceutical order falls outside industry standards and clinical guidelines, instituting a formal review of said pharmaceutical order by another healthcare professional and requiring consensus before said pharmaceutical order is accepted and said registration process is completed.

8. The method of claim 1, further comprising:
receiving modifications to said pharmaceutical agent in said database for an individual participant, and providing a revised pharmaceutical profile of said individual participant to said healthcare professional.

9. The method of claim 8, wherein on condition that said modifications to said pharmaceutical agent fall outside industry standards and clinical guidelines, instituting a formal review of said pharmaceutical order by another healthcare professional and requiring consensus before said modifications to said pharmaceutical agent are accepted.

10. The method of claim 1, further comprising:
notifying said individual participant each time said data in said database on said individual participant, is accessed by a healthcare professional.

11. The method of claim 9, wherein said individual participant can modify access by individual healthcare professionals, to said data on said individual participant in said database.

12. The method of claim 1, further comprising:
verifying said plurality of participants using at least one of demographic, occupational, education, training, licensing, credentialing, certification, and medico-legal data.

13. The method of claim 12, wherein said verification step includes the use of biometrics, speech analysis, and unique data identifiers, and said verification step takes place each time an individual participant or a healthcare professional, accesses said database.

14. A system which tracks pharmaceuticals, comprising:
at least one memory which contains at least one program which comprises the executable instructions of:
receiving data on a plurality of participants and a plurality of pharmaceutical agents in a registration process, and storing said data in a database of a computer system;
receiving input on a pharmaceutical agent for an individual participant and storing said input on said pharmaceutical agent in said database;
displaying on a display of said computer system, a timeline for said individual participant, summarizing a pharmaceutical history of said individual participant for all pharmaceutical prescriptions and pharmaceutical agents stored in said database;
analyzing data in said database, using a processor of said computer system, wherein on condition that said pharmaceutical agent is one of said plurality of pharmaceutical agents, and on condition that said individual participant is one of said plurality of participants, determining a clinical appropriateness of said pharmaceutical agent for said individual participant;
displaying, on a display of said computer system, default data from said database on said pharmaceutical agent, to complete standardized data fields on said pharmaceutical agent for said individual participant; and
verifying that said completed data fields on said pharmaceutical agent for said individual participant are consistent with industry standards and clinical guidelines; and
at least one processor which executes the program.

15. A non-transitory computer-readable medium which includes instructions for tracking pharmaceuticals, comprising:
receiving data on a plurality of participants and a plurality of pharmaceutical agents in a registration process, and storing said data in a database of a computer system;
receiving input on a pharmaceutical agent for an individual participant and storing said input on said pharmaceutical agent in said database;
displaying on a display of said computer system, a timeline for said individual participant, summarizing a pharmaceutical history of said individual participant for all pharmaceutical prescriptions and pharmaceutical agents stored in said database;
analyzing data in said database, using a processor of said computer system, wherein on condition that said pharmaceutical agent is one of said plurality of pharmaceutical agents, and on condition that said individual participant is one of said plurality of participants, determining a clinical appropriateness of said pharmaceutical agent for said individual participant;
displaying, on a display of said computer system, default data from said database on said pharmaceutical agent, to complete standardized data fields on said pharmaceutical agent for said individual participant; and
verifying that said completed data fields on said pharmaceutical agent for said individual participant are consistent with industry standards and clinical guidelines.

16. A computer-implemented method of dispensing a pharmaceutical, comprising:
receiving data on a pharmaceutical agent to be dispensed in a database of a computer system;
requiring mandatory recording of a quantity of said pharmaceutical agent to be dispensed, at a time of dispersal, in said database;
correlating data on said pharmaceutical agent being dispensed, with a quantity in inventory and information on said pharmaceutical agent in said database;
verifying quantity and identify of said dispersed pharmaceutical agent at said time of dispersal, with said quantity and information on said pharmaceutical agent in said database; and
sending an alert using electronic means, to predetermined parties, on condition that said quantity or said identity of said dispersed pharmaceutical agent is not verified at dispersal.
